(19) United States
(12) Patent Application Publication
(10) Pub. No.: US 2003/0017870 A1
(43) Pub. Date: Jan. 23, 2003

(54) Game-credit control and accounting apparatus

(76) Inventor: Gordon C. Klein, Terre Haute, IN (US)

Correspondence Address: BARNES & THORNBURG, 11 SOUTH MERIDIAN, INDIANAPOLIS, IN, 46204

(21) Appl. No.: 10/122,752

(22) Filed: Apr. 15, 2002

Related U.S. Application Data
(63) Continuation of application No. 09/618,258, filed on Jul. 18, 2000, now abandoned.
Application No. 09/618,258 is a continuation-in-part of application No. 08/947,591, filed on Oct. 9, 1997, now Pat. No. 6,089,979.
(60) Provisional application No. 60/028,300, filed on Oct. 11, 1996.

(51) Int. Cl. G06F 19/00

(52) U.S. Cl. 463/25

(57) ABSTRACT

A game credit controller and accounting system for use with a plurality of gaming machines including game boards for accumulating credits earned and purchase on the gaming machine includes a game unit located with each of the plurality of gaming machines for receiving credit data from the gaming unit and transmitting the credit data to a credit controller located in a collection are remote from the plurality of gaming machines.

### CROSS REFERENCE TO RELATED APPLICATION AND CLAIM PRIORITY

This application is continuation of U.S. patent application Ser. No. 09/618,258 filed Jul. 18, 2000 which is a continuation-in-part of U.S. patent application Ser. No. 08/947,591 filed Oct. 9, 1997, which was issued as U.S. Pat. No. 6,089,979 on Jul. 18, 2000. That application claims benefit under 35 U.S.C. § 119(e) of U.S. Provisional Patent Application Serial No. 60/028,300, which was filed on Oct. 11, 1996.

### BACKGROUND AND SUMMARY OF THE INVENTION

The present invention relates to an apparatus that controls the credits of a gaming machine. More particularly, the present invention relates to a game-credit control apparatus that removes and transfers game credits from a gaming machine to a redemption center at a location remote from the gaming machine.

It is known to remotely credit and bill usage of electronic entertainment machines, see for example U.S. Pat. Nos. 5,197,094 and 5,429,361. These conventional systems, however, require expensive technology such as modems or card readers, keypads, and the like. In small establishments having a limited number of gaming machines, it would be desirable to have a game-credit control and accounting apparatus that monitors multiple gaming machines using relative inexpensive technology. Cost savings to the establishment can be achieved through the relatively low cost of the control and accounting device as well as the reduced labor expense since employees may remain in a central work area and carry on with other duties while redeeming game credits.

According to the present invention a game-credit control apparatus suitable for use with gaming machines each configured to store accumulated credits in response to a game and to transmit a counter signal of accumulated credits in response to receiving a reset signal is provided. The game-credit control apparatus comprises a junction box with junction ports, each junction port being formed for communication with one gaming machine, a credit controller with a connector communicating with the junction box, and reset switches. The reset switches communicate with the connector and selectively trigger a reset signal. In addition, each reset switch corresponds to one of the junction ports. The control apparatus of the present invention further comprises a payout counting mechanism communicating with the connector. The payout counting mechanism is formed to receive the counter signal of accumulated credits.

According to another aspect of the present invention a game-credit control apparatus suitable for use with a plurality of gaming machines each configured to store accumulated credits in response to a game and to transmit a counter signal of accumulated credits in response to receiving a reset signal is provided. The game-credit control apparatus comprises a pulse collection unit for each of the plurality of machines, each pulse collection unit having a transceiver for sending and receiving information including a tag which differs from each of the other transceivers of the other pulse collection units. A credit controller having a transceiver for sending and receiving information including each of the tags and a reset switch is in communication with each of the pulse control units. The reset switch triggers a reset signal accompanied by one of the tags. The control apparatus of the present invention further comprises a payout counting mechanism communicating with the controller. The payout counting mechanism is formed to receive the counter signal of accumulated credits.

Additional features, and advantages of the invention will become apparent to those skilled in the art upon consideration of the following detailed description of the preferred embodiment exemplifying the best mode of carrying out the invention as presently perceived.

### BRIEF DESCRIPTION OF THE DRAWINGS

The detailed description particularly refers to the accompanying figures in which:

FIG. 1 is a diagrammatic illustration of a floor plan that includes six gaming machines coupled to a game-credit control apparatus in accordance with the present invention and showing the control apparatus including a junction box in communication with a credit controller;

FIG. 2 is a top view of the credit controller showing the credit controller having credit clearing buttons and resettable hard counters;

FIG. 3 is a flow chart of the game credit-control apparatus of FIG. 1;

FIG. 4 is a diagrammatic view of a game credit-control apparatus in accordance with an alternative embodiment of the present invention attached to a gaming machine showing the control apparatus having a junction box, a credit controller, and an accounting recorder including a credit take-in counter and a pay-out counter;

FIG. 5 is a flow chart of the game credit-control apparatus of FIG. 4;

FIG. 6 is a diagrammatic view of the game credit-control apparatus of FIG. 4;

FIG. 7 a diagrammatic view of a game credit-control apparatus in accordance with another alternative embodiment of the present invention attached to a gaming machine showing the control apparatus having the junction box, the accounting recorder, and a printer controller coupled to a printer and a power supply;

FIG. 8 is a flow chart of the game credit-control apparatus of FIG. 7;

FIG. 9 is a diagrammatic view a game credit-control apparatus in accordance with another alternative embodiment of the present invention showing the printer controller including a print report button, a clear memory key switch, reset buttons, and light emitting diodes;

FIG. 10 is a flow chart of the game credit-control apparatus of FIG. 9;

FIG. 11 is a diagrammatic view of the game credit-control apparatus in accordance with another alternative embodiment of the present invention showing the control apparatus including a junction box in communication with both a credit controller and an accounting recorder;

FIG. 12 is a flow chart of the game credit-control apparatus of FIG. 1;

FIG. 13 is a diagrammatic illustration of a floor plan that includes six gaming machines each coupled to a game-credit control apparatus in accordance with the present invention and showing the control apparatus including a pulse collection unit in each gaming machine in communication with a credit controller which is in communication with a printer controller;

FIG. 14 is a view of the game credit control apparatus of FIG. 13 with parts broken away showing a pulse collection unit in each of three gaming machines, a credit controller having credit clearing buttons and resettable hard counters, and a printer for printing game credit information;

FIG. 15 is an exploded view of the credit controller of FIG. 14;

FIG. 16 is a view of several accounting tickets;

FIGS. 17A-17 are schematics of the pulse control unit of FIG. 13; and

FIGS. 18A-18 are schematics of the credit controller of FIG. 13.

### DETAILED DESCRIPTION OF THE DRAWINGS

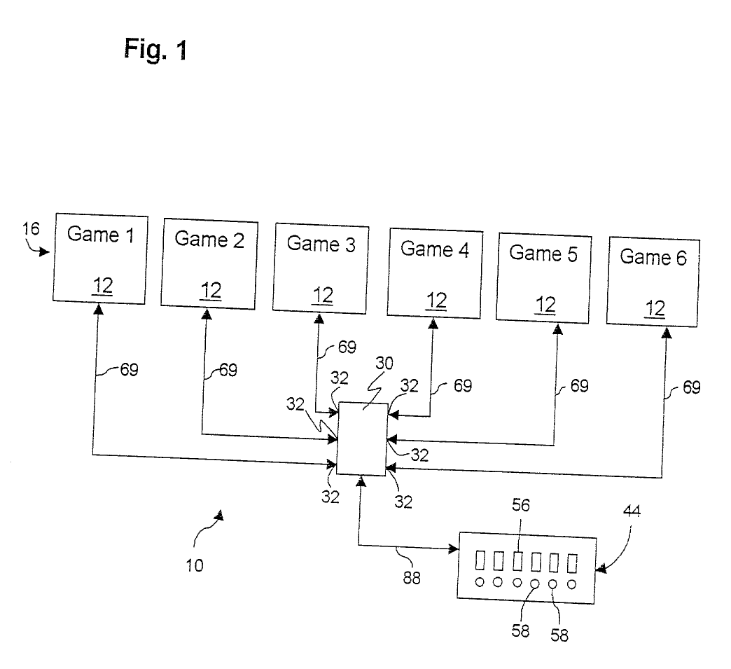

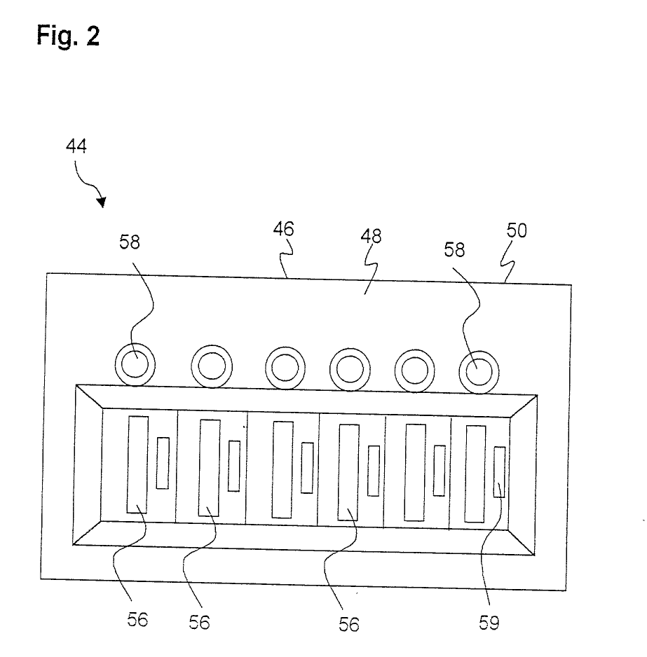

As shown in FIG. 1, a game-credit control apparatus 10 in accordance with the present invention is designed to remove and transfer game credits from gaming machines 12 to a credit controller 44 positioned in a location remote from gaming machines 12. Control apparatus 10 is situated in an establishment (not shown) remote from gaming machines 12. Control apparatus 10 is suited for use with gaming machines 12 that are capable of receiving tokens and coins of various values as well as cards that contain various credit values. As shown in FIG. 1, control apparatus 10 is suitable for use with a bank 16 of six gaming machines 12 that are positioned to lie in a side-by-side relationship. It is understood, however, that gaming machines 12, may be scattered throughout the establishment and bank 16 may include three gaming machines or greater or fewer than six gaming machines 12 in accordance with the present invention. Although one gaming machine 12 will be discussed hereafter, it is understood that the discussion applies to each gaming machine 12.

Gaming machine 12 is a representative video poker machine provided with a cabinet (not shown) having a video screen (not shown) and displaying a plurality of visual displays (not shown) that interact with the player's input and display the number of credits that the player has accumulated. Control apparatus 10 in accordance with the present invention is equally appropriate for use with video slot machines. Control apparatus 10 may also be used with other types of gaming machines that store credits based upon the number of credits the users supply to gaming machine 12 and upon the outcome of the games played.

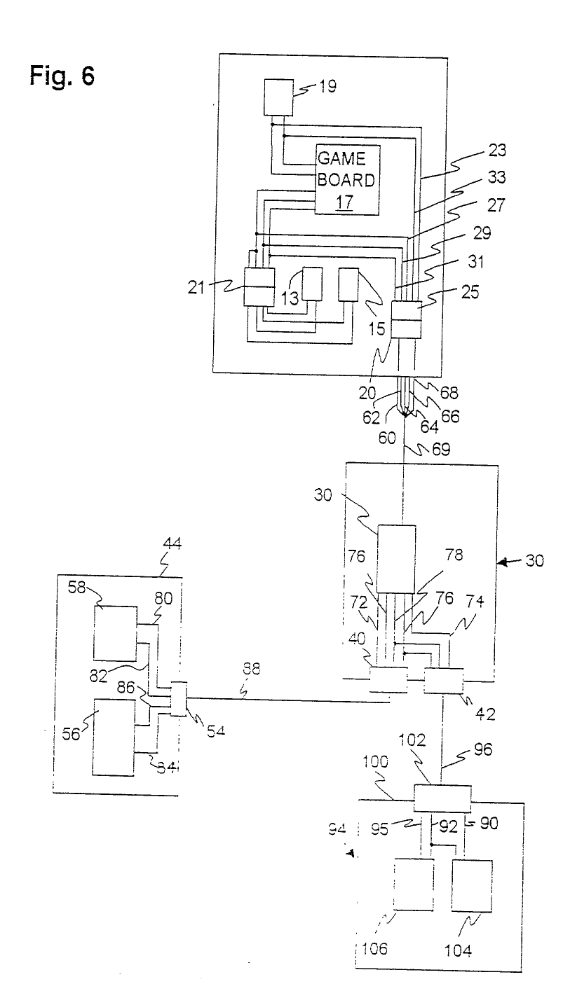

As shown, for example, in FIG. 6, gaming machine 12 has a game board 17 within the cabinet (not shown), a game harness 25 that cooperates with game board 17, a second game harness 20 coupled to game harness 25, a gaming-machine counter harness 21, a gaming-machine in-counter 13, and a gaming-machine out-counter 15. Game board 17 is powered by gaming machine 12 and transfers the total number of credits purchased by the player as well as the amount of credits the player has won or lost to game harness 25 and to gaming-machine counter harness 21. Gaming-machine counter harness 21 is in communication with gaming-machine in-counter 13 and a gaming-machine out-counter 15.

As shown in FIG. 6, Gaming machine 12 also includes an external reset push-button switch 19, or has two external wing nuts (not shown) that are in communication with game board 17 and are connected to allow clearing of the current credit totals from gaming machine 12. Credit totals are cleared from gaming machine 12 either by pressing push-button switch 19 or by touching both wing nuts (not shown) with a coin or other metal object. Also connected to game harness 25 are a system ground 23 and a reset signal via wire 33. In normal operation, game harness 25 is configured to receive an input counter signal indicating the amount of credit purchased for game via a wire 27. Once the player has finished playing gaming machine 12, gaming machine receives a signal via a wire 29 indicating the total amount of credits cashed-in. In addition, gaming machine has a twelve volt power line 31.

Control apparatus 10 of the present invention exploits power line 31, system ground 23, and the signals conveyed by wires 27, 29, 33 that are present on game board 17 to remove and transfer game credits to a remote location. To exploit game board 17, it is necessary to first connect system ground 23 to reset push-button switch 19. In addition, gaming machine counter harness 21 is disconnected from in and out counters 13, 15 because control apparatus 10 eliminates the need for in-counters 13 and out-counters 15 mounted on gaming machine 12. Although game boards 17 and game harnesses 25 have been described herein, it is understood that a wide variety of game boards and game harness that are commercially available and are well known within the gaming device industry are suitable for use with the present invention.

Control apparatus 10 of the present invention exploits game board 17, power line 31, system ground 23, and signals 27, 29, and 33 from gaming machine 12 and game harness 20 to remove game credits from bank 16 of gaming machines and to transfer the calculated game credit totals. As shown in FIG. 1, control apparatus 10 includes a junction box 30 and a credit controller 44. Each bank 16 of gaming machines 12 is provided with junction box 30. Junction box 30 communicates with each of game board 17 within bank 16 of gaming machines 12 via game harness 25 and is in electronic communication with credit controller 44. As shown in FIG. 1, junction box 30 includes six junction ports 32 and one gaming machine 12 is assigned one of the ports 32. It is understood, however that while six gaming machines 12 and a junction box 30 with six junction ports 32 are illustrated in FIG. 1, three junction ports or greater or fewer than six gaming machines 12 and a junction box 30 with greater or fewer than six junction ports 32 may be controlled and monitored by control apparatus 10 of the present invention.

Junction box 30 has side walls (not shown) and a cover (not shown) that cooperate to define a chamber (not shown) therein. Credit control connector 40 and accounting center connector 42 are mounted on one of side walls. See FIG. 6. Junction ports 32 extend through cover (not shown). Referring now to FIG. 6, junction box 30 is coupled to a reset wire 60 and a ground wire 62 that extend into harness 20 that is coupled to internal game harness 25. Thus, wires 60, 62 communicate with wires 33, 23 in gaming machine 12. In addition, game harness 20 of gaming machine 12 couples input counter wire 27 to a counter wire 64, twelve volt power line 31 to a power supply wire 66, and output counter wire 29 with a payout counter wire 68. As shown in FIG. 6, wires 60, 62, 64, 66, 68 extend as a bundle 69 into junction port 32 of junction box 30. Junction port 32 attaches wires 60, 62, 64, 66, 68 to counterpart wires within junction box 30.

Illustratively, junction box 30 houses a junction reset wire 70 that is connected to wire 60 and a junction ground wire 72 that is connected to wire 62. Reset and ground wires 70, 72 extend between junction port 32 and credit control connector 40. A junction payout counter wire 76 is connected to wire 68 and is split within junction box 30. Thus, payout counter wire 76 extends between junction port 32 and credit control connector 40 and accounting center connector 42. A junction power supply wire 78 is connected to power supply wire 66 and is also split within junction box 30. Power supply wire 78, therefore extends between junction port 32 and credit control connector 40 and accounting center connector 42. A junction power supply wire 78 is connected to power supply wire 66 and is also split within junction box 30. Power supply wire 78, therefore extends between junction port 32 and credit control connector 40 and accounting center connector 42.

Credit controller 44, as shown in FIGS. 1 and 2, includes a housing 46 that has a front face 48 and side walls 50 that define a cavity (not shown). In addition, one side wall 50 of housing 46 receives a wire connector 54 therein. See FIG. 6. A bank of six payout counters 56 and a bank of credit clearing buttons 58 extend through front face 48 of housing 46. As best shown in FIG. 2, each payout counter 56 is a resettable hard counter that includes a manual reset button 59 configured to clear the displayed credits on payout counter 56. It is understood, however, that a wide variety of resettable counters such as digital and the like are suitable for use with the present invention. Credit clearing buttons 58 are push-button switches, although it is understood that a variety of commercially available switches are suitable for use with the present invention.

While the electronic connection between one payout counter 56 and one clearing button 58 of controller 44 will be described, it is understood that the described connection applies to each payout counter 56 and clearing button 58. It is also understood that while six payout counters 56 and six buttons 58 are illustrated in FIG. 1, three payout counters and three buttons or greater or fewer than six payout counters 56 and six buttons 58 may be controlled and monitored by credit controller 44 of control apparatus 10 of the present invention.

As shown in FIG. 6, a controller reset wire 80 and a controller ground wire 82 extend between button 58 and wire connector 54 in credit controller 44. A controller counter wire 84 and a controller supply power wire 86 extend between payout counter 56 and wire connector 54. A connection cable 88 extends between wire connector 54 of credit controller 44 and credit control connector 40 of junction box 30. Connection cable 88 is formed to attach controller reset wire 80, controller ground wire 82, controller counter wire 84, and controller supply power wire 86 within credit controller 44 with corresponding wires 70, 72, 76, 78 within junction box 30.

In operation, payout counter 56 of credit controller 44 does not continuously monitor the stored credits of gaming machines 12. Rather, counter 56 is triggered upon the cashier pressing clearing button 58 on credit controller 44 that corresponds to gaming machine 12 that is being cashed-out by a player. To operate control apparatus 10, the player approaches credit controller 44 that is located within the establishment and remote from gaming machine 12 after playing gaming machine 12. The cashier must first be sure credits have been cleared from appropriate payout counter 56 before tallying the payout due to the player. As shown in FIG. 2, this credit clearing from counter 56 is performed by pressing clearing button 59 on payout counter 56.

To determine the proper payout due to the player, the cashier must only press credit clearing/reset button 58 on credit controller 44 that corresponds to gaming machine 12 that is being cashed-out by a player. Once reset button 58 is pressed, a reset signal is carried from credit controller 44 into individual game 12 where credits are cleared from game board 17 to reset the total credit amount to zero for that particular gaming machine. Game board 17, upon receiving reset signal also sends a pay-out counter signal to game harness 25. Harness 20 receives signal and carries signal back to junction box 30 where it is sent to payout counter 56 of credit controller 44.

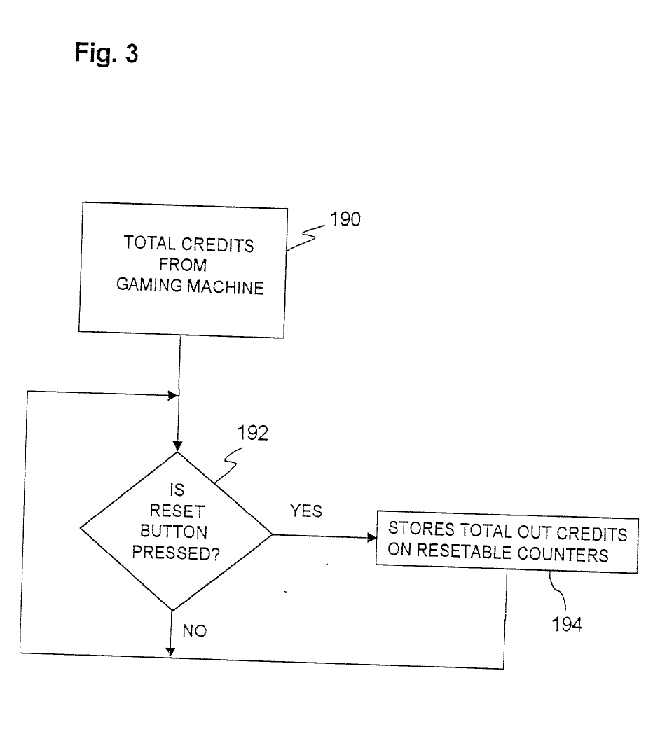

As shown in FIG. 3, the total credits from gaming machine (box 190) are stored in gaming machine. Control apparatus 10 includes reset button and operates depending upon whether reset button is pressed (box 192). If reset button is pressed, credit controller stores the total out credits on the appropriate resettable counter (box 194). After storing the total out credits, or if the answer to box 192 is no, control apparatus 10 awaits the pressing of the reset button.

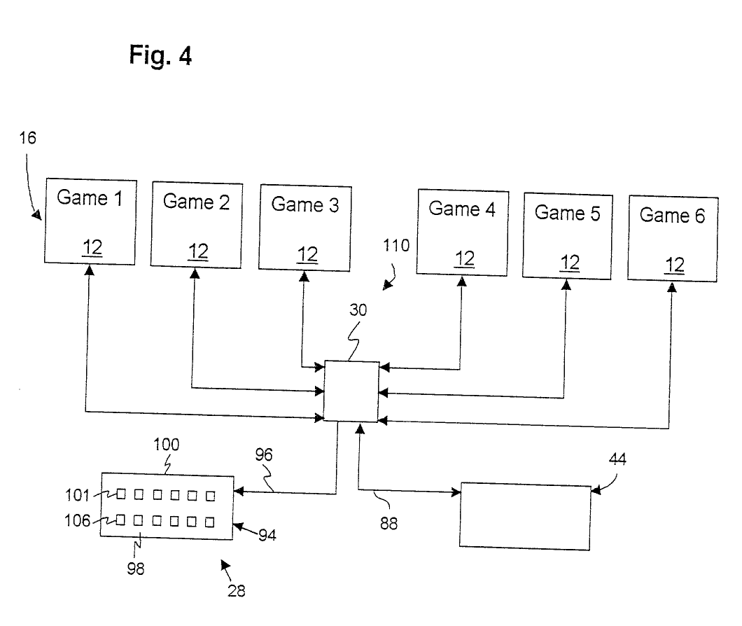

In an alternative embodiment of the present invention, a game-credit control apparatus 110 exploits existing game board 17, power line 31, system ground 23, and signals 27, 29, and 33 from gaming machine 12 and game harness 20 to remove game credits from bank 16 of gaming machines 12 and to transfer the calculated game credit totals to credit controller 44 as well as to an accounting center 28. Control apparatus 110 is shown in FIG. 4 and includes junction box 30, credit controller 44 and an accounting recorder 94 that is located within accounting center 28 or other convenient area.

Accounting recorder 94 is shown in FIG. 4 and includes a front wall 98 and side walls 100. One side wall 100 receives a wire connector 102 therein. See FIG. 6. A bank of six credit take-in counters 104 and a bank of six credit pay-out counters 106 extend through front face 48 of housing 46. Counters 104 and 106 are nonresettable hard counters. It is understood, however, that a wide variety of commercially available counters may be used in accordance with the present invention. While the electronic connection between one counter 104 and one counter 106 of recorder 94 will be described, it is understood that the described connection applies to each counter 104, 106. It is also understood that while six counters 104 and six counters 106 are illustrated and described herein, three counters 104 and three counters 106 or greater or fewer than six counters 104, 106 may be included in accounting recorder 94 of control apparatus 10 of the present invention.

An accounting power supply wire 92 extends between wire connector 102 and both counters 104, 106. See FIG. 6. An accounting input wire 90 extends between take-in counter 104 and wire connector 102 and an accounting output counter wire 95 extends between pay-out counter 106 and wire connector 102. A connection cable 96 extends between wire connector 102 and accounting center connector 42 of junction box 30. As best shown in FIG. 6, connection cable 96 is formed to attach accounting power supply wire 92, accounting input wire 90, and controller counter wire 84, and accounting output counter wire 95 of accounting recorder 94 with corresponding junction power supply wire 78, junction counter wire 74, and junction payout counter wire 76 within junction box 30.

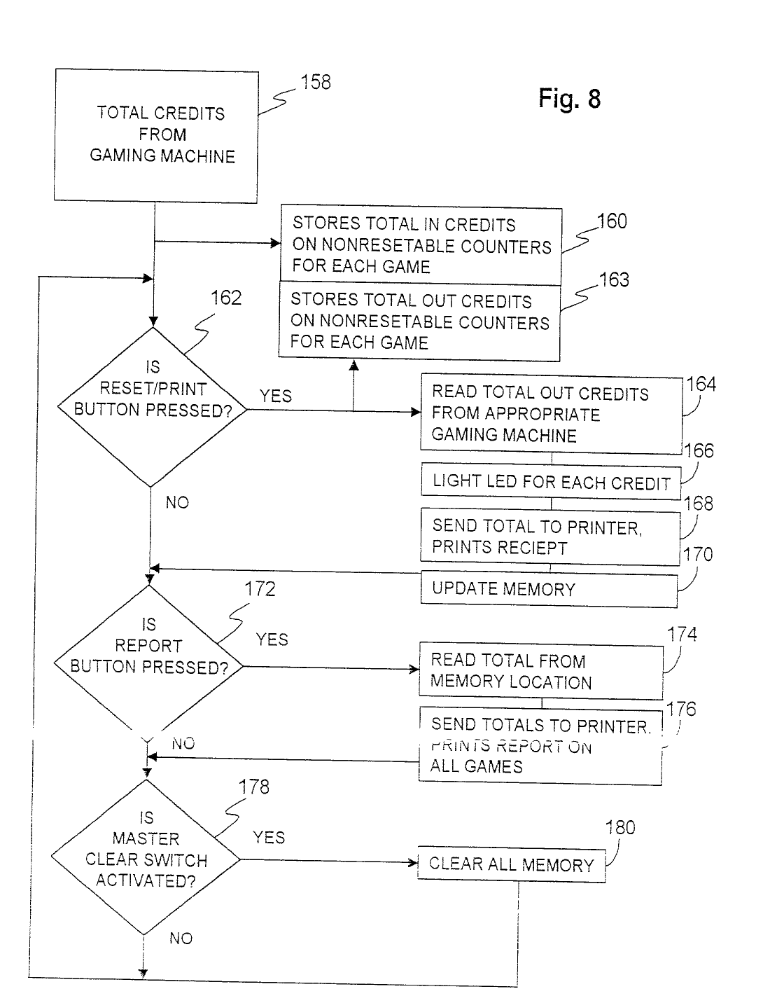

To operate control apparatus 110 of the present invention, a player inserts a valid token or coin to into gaming machine 12 to play the game. A validator (not shown) present within gaming machine 12 sends an input signal to game board 17. Game board 17, in turn, sends the signal indicating the number of credits purchased via wire 27 to game harness 25. Harness 20 of control apparatus 10 receives signal indicating the number of credits purchased and transmits the input signal to junction box 30 and therefore to credit take-in counter 104 of accounting recorder 94. See FIG. 8. Thus, control apparatus 10 allows the operator of the gaming area to continuously monitor the amount of tokens or credits placed into each gaming machine 12 from accounting area 28 remote from gaming machine 12.

After playing gaming machine 12, the player approaches credit controller 44 that is located within the establishment and remote from gaming machine 12. Cashier clears the credits from appropriate counter 56 before tallying the payout due to the player and determines the proper payout due to the player as previously discussed. In addition, pay-out counter signal is split within junction box 30 and is also transmitted to pay-out counter 106 of accounting recorder 94. See FIG. 8. Pay-out counter 106 is only activated when the cashier presses credit clearing button 58. Thus, by comparing credit take-in counter 104 and pay-out counter 106, personnel in accounting center 28 can cross-check the total amount of credit purchased with the total amount of credit paid-out from each gaming machine 12. Pay-out counter 106 also provides personnel with sufficient information to cross-check the cashiers' drawer with the proper amount of credit that was to be paid out.

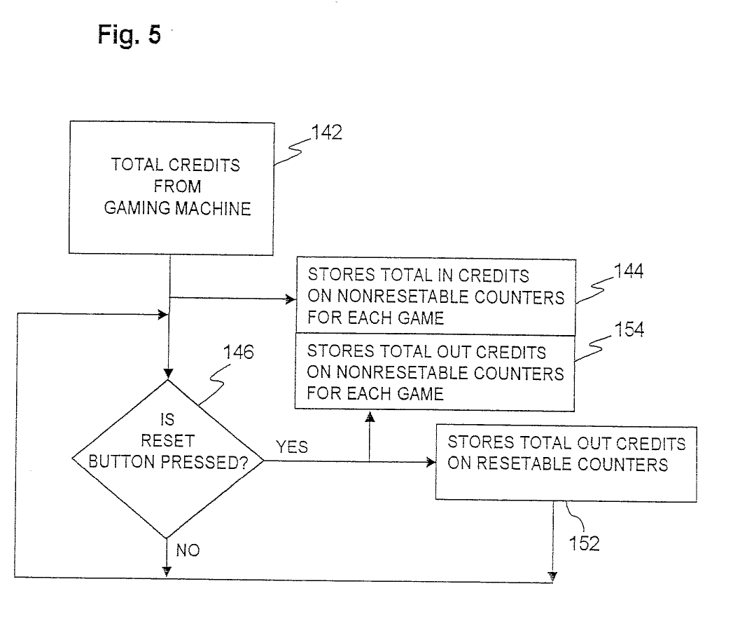

Thus, as shown in FIG. 5, control apparatus 110 operates upon receiving a credit into gaming machine (box 142) and upon the pressing of the reset button (box 146). If a credit is received, the credit is sent to the appropriate credit take-in counter of the accounting controller (box 144). After the task of box 144 is completed or if a credit was not received, control apparatus 110 awaits either the insertion of another credit or the pressing of the reset button (box 146). If reset button is pressed, the total credits from the appropriate gaming machine are read and sent to resettable counter of credit controller (box 152). In addition, the total credits are sent to pay-out counter of accounting recorder (box 154). If the reset button is not pressed, control apparatus 110 again awaits either the insertion of another credit (142) or the pressing of reset button (146).

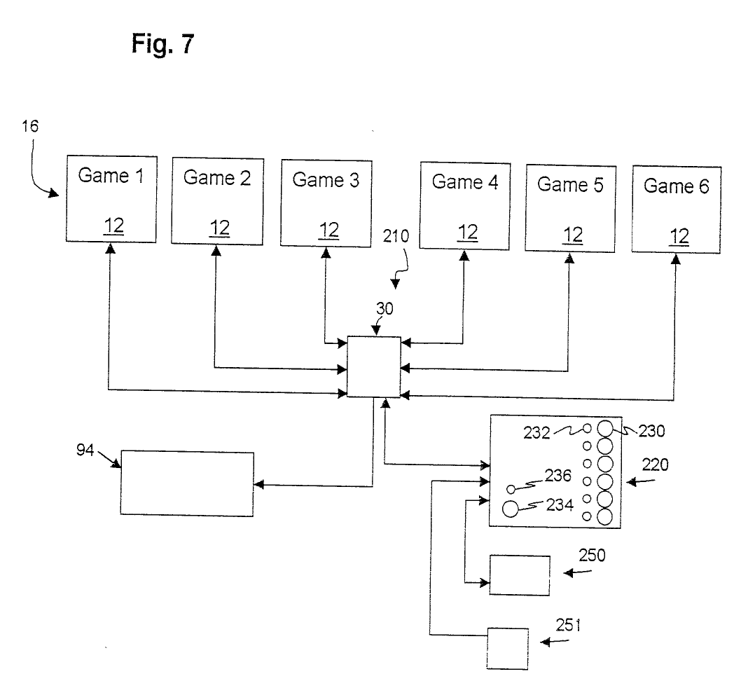

In still another embodiment of the present invention, a game-control apparatus 210 exploits existing game board 17, power line 31, system ground 23, and signals 27, 29, and 33 from gaming machine 12 and game harness 20 to remove game credits from bank 16 of gaming machines 12 and to transfer the calculated game credit totals to accounting center 28 as well as to print out the calculated game credit totals. Control apparatus 210 includes junction box 30, accounting recorder 94, and a printer controller 220. As shown in FIG. 7, printer controller 220 includes a bank of reset buttons 230 and a bank of LEDs 232. In addition, a print report button 234 as well as a clear memory key switch 236 are included in printer controller 220.

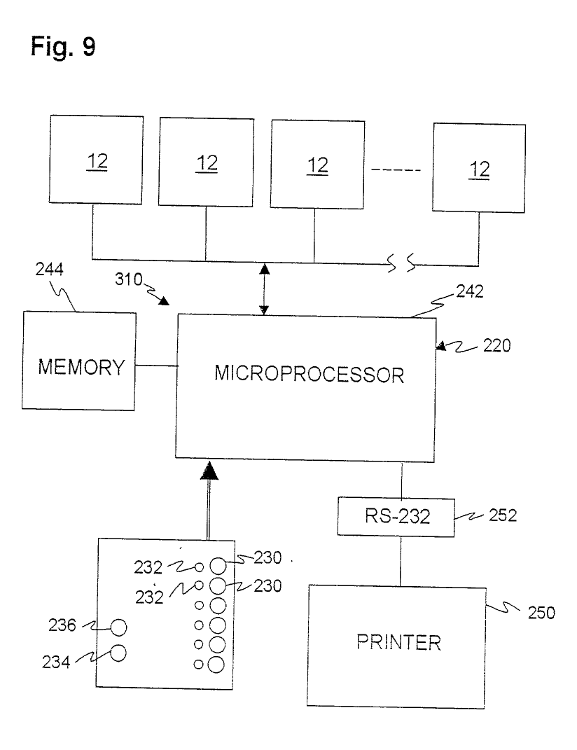

Referring to FIG. 9, printer controller 220 includes a microprocessor 242 model #PIC16C65A-10-P manufactured by Microchip Technology Inc., Chandler, AZ and a memory unit 244. It is understood that a variety of microprocessors are suitable for use with the present invention. Printer controller 220 communicates with gaming machines 12 via junction box 30. Junction box 30 is coupled to gaming machine 12 as previously discussed. As shown in FIG. 9, reset buttons 230 are coupled to computer and junction box 30. In addition, microprocessor 242 is coupled to printer 250 via a RS-232 connector 252 and is coupled to an AC adapter (See FIG. 7). It is understood, however, that a wide variety of connectors may be used in accordance with the present invention.

Control apparatus 210 of the present invention operates upon receiving a valid token or coin to into gaming machine 12 to play the game (box 158). If a credit is received, the credit is sent to and stored in the appropriate take-in counter of the accounting controller (box 16), upon the pressing of reset/print button (box 162), the pressing of report button (box 172), or activating of master clear switch (box 178). See FIG. 8. Upon completing game play, the player must only press reset/print button 230 on printer controller 220 (box 162) that corresponds to gaming machine 12 that player is cashing-out. If reset button 230 is pressed, a reset signal is sent through junction box 30 to game board 17. The reset signal clears credits from game board 17 to reset the credit amount to zero for that particular gaming machine.

In addition, as shown in box 164, if reset/print button is pressed (box 162), printer control 220 reads the total credits from the appropriate gaming machine (box 164). Then, the game board 17 sends a pay-out counter signal to game harness 25. Harness 20 receives the pay-out signal and transmits payout signal back to junction box 30 where it is sent to printer controller 220. Printer controller 220 receives payout signal and directs it to computer where, as shown in FIGS. 7-9, the LED is illuminated adjacent pressed reset button 230 that corresponds to gaming machine 12 that is being cashed-out (box 166).

The total credits are sent to the printer (box 168) where a report showing credits at time of redemption are printed. In addition, the stored memory in the memory unit 244 is updated (box 170) by adding the total credits to the stored total for each gaming machine 12. It is understood that memory unit 244 may store the information from gaming machines 12 in a variety of formats suitable to meet a variety of business needs. Additionally, if reset/print button is pressed (box 162) the accounting recorder stores the total out credits for each game (box 163).

After updating the stored memory, or if rest/print button has not been pressed, microprocessor 242, checks to see if the report button 234 has been pressed (box 172). If the report button is pressed, microprocessor 242 reads the total credits for all gaming units 12 from an appropriate memory location in memory unit 244 (box 174) and send them to printer 250 (box 176). It is understood that the report may be printed in a variety of formats, depending upon the business needs of the user. After sending the total credits to printer (box 176), or if report button is not pressed, microprocessor 242 checks to see if master clear switch 236 is activated (box 178). If master clear switch is activated, the memory unit is cleared of all of the stored memory (box 180). This clearing enables users to reset the collected credits to zero for each business day or other pre-determined passage of time. After clearing the memory, or if master clear switch is not activated, microprocessor 242 checks to see if any of reset/print buttons 230 have been pressed or activated (box 162).

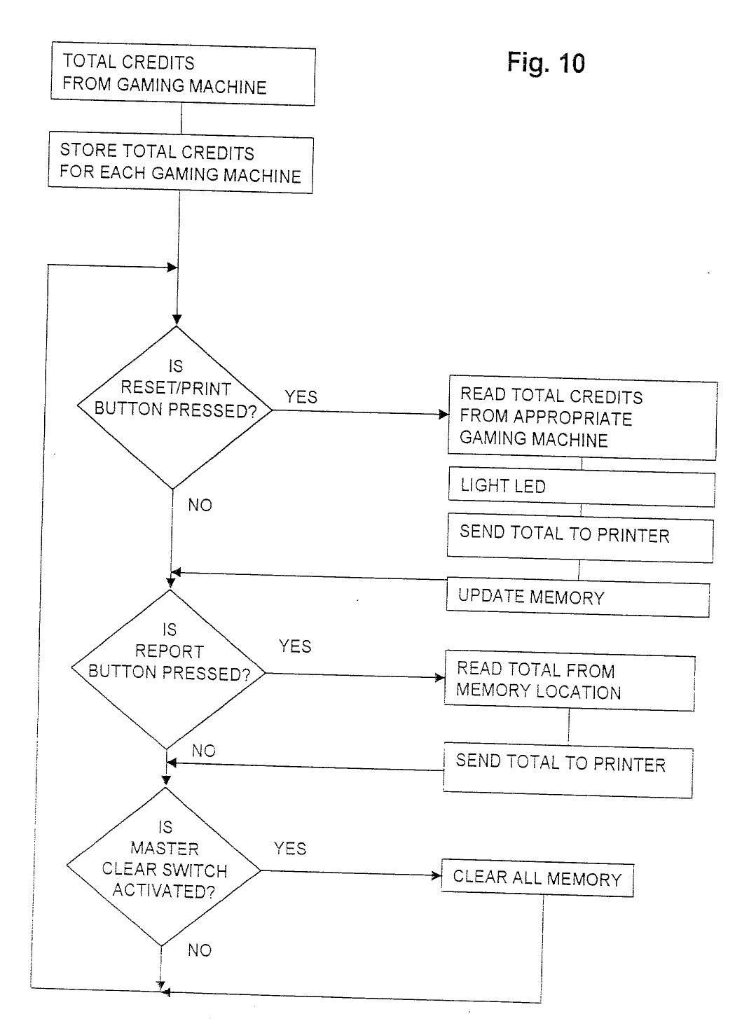

In still another alternative embodiment of the present invention, game credit-control apparatus 310 is provided. See FIGS. 9 and 10. Control apparatus 310 exploits existing game board 17, power line 31, system ground 23, and signals 27, 29, and 33 from gaming machine 12 and game harness 20 to remove game credits from bank 16 of gaming machines 12 and to transfer the calculated game credit totals to printer controller 220 to print out the calculated game credit totals. Control apparatus 310 includes junction box (not shown) and a printer controller 220. Junction box and printer controller 220 are formed as previously discussed. Control apparatus 310 includes printer controller 220 coupled to printer 250 and power supply 251. Control apparatus 310 operates as illustrated in FIG. 10.

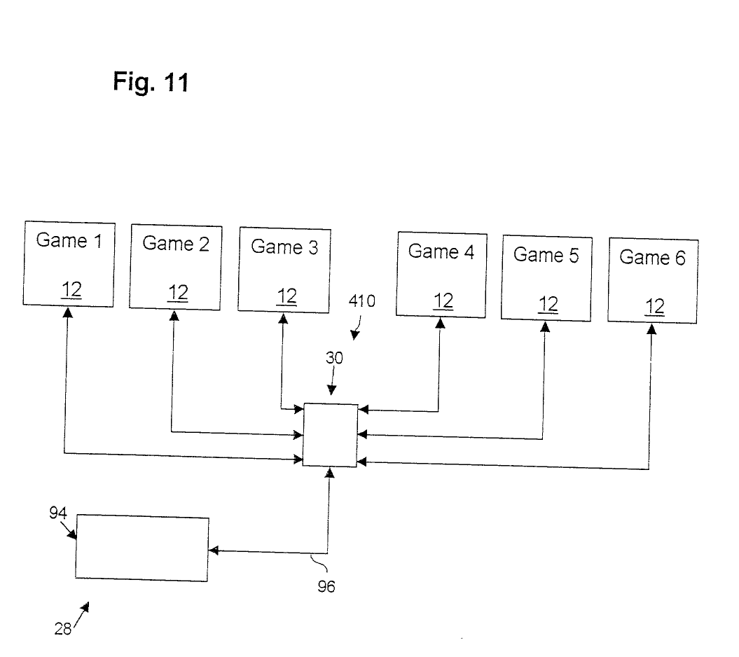

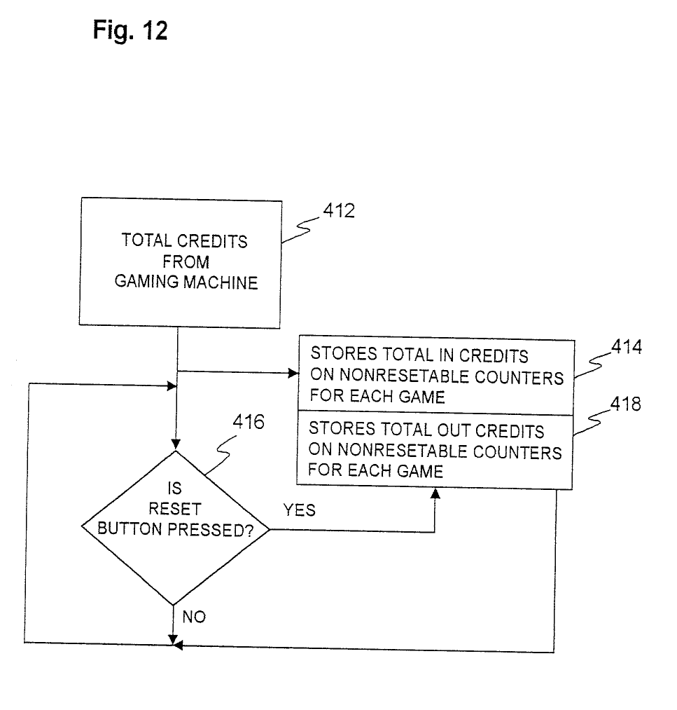

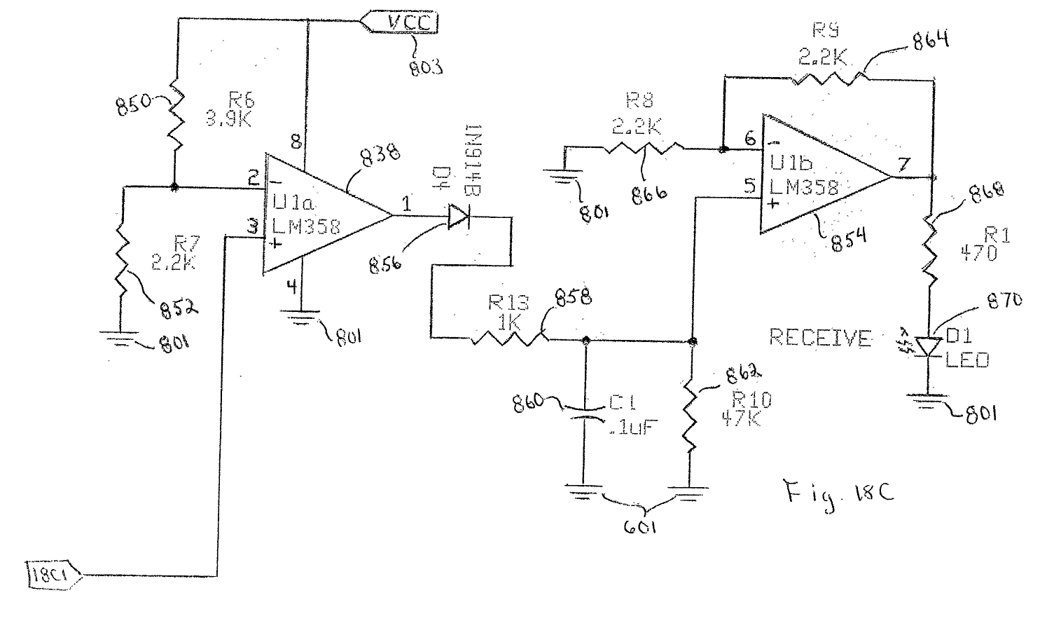

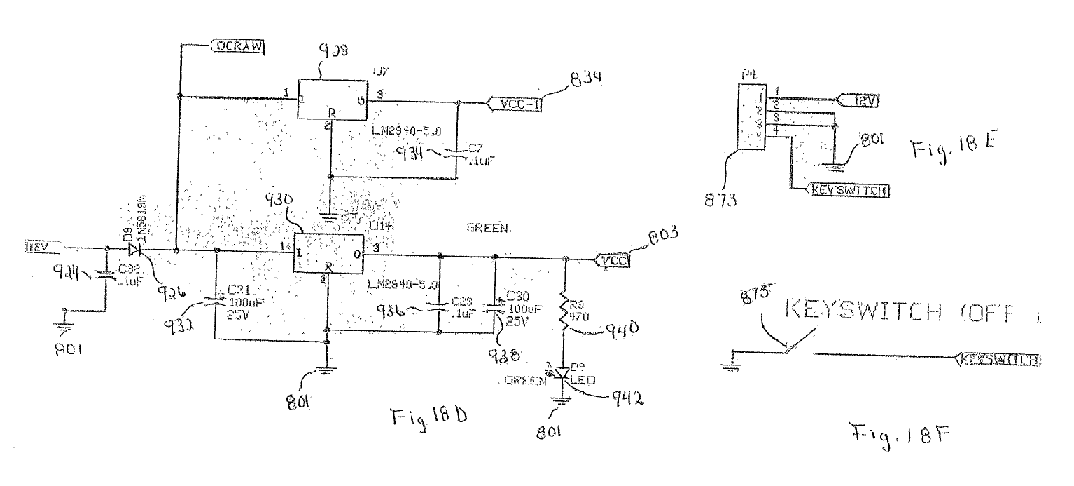

Referring now to FIGS. 11 and 12, an alternative embodiment of game-credit control apparatus is illustrated. Control apparatus 410 includes accounting center 28 that includes a reset button. Referring now to FIG. 14, the total credits from gaming machine are stored in gaming machine (box 412). Control apparatus 410 operates by storing total in-credits on nonresettable counters for each game (box 414). Control apparatus 410 also operates depending upon whether reset button is pressed (box 416). If reset button is pressed, the total-out credits are stored on nonresettable counters for each game (box 418). After storing the total-out credits, or if the rest button is not pressed, control apparatus 410 continues to store the total-in credits on nonresettable counters for each game.

A control apparatus in accordance with the present invention transfers credit input and payout counts to a remote control center and to a remote accounting center. Thus, employees may remain in a central work area and carry on with other duties while redeeming game credits. In addition, the control apparatus does not interfere with other video games or players during credit redemption.

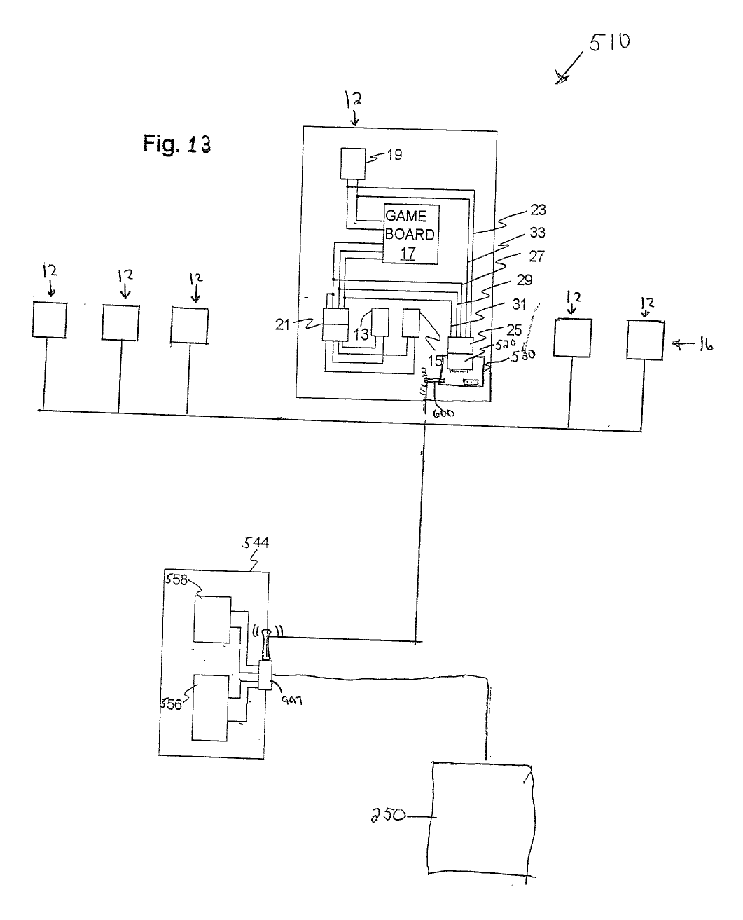

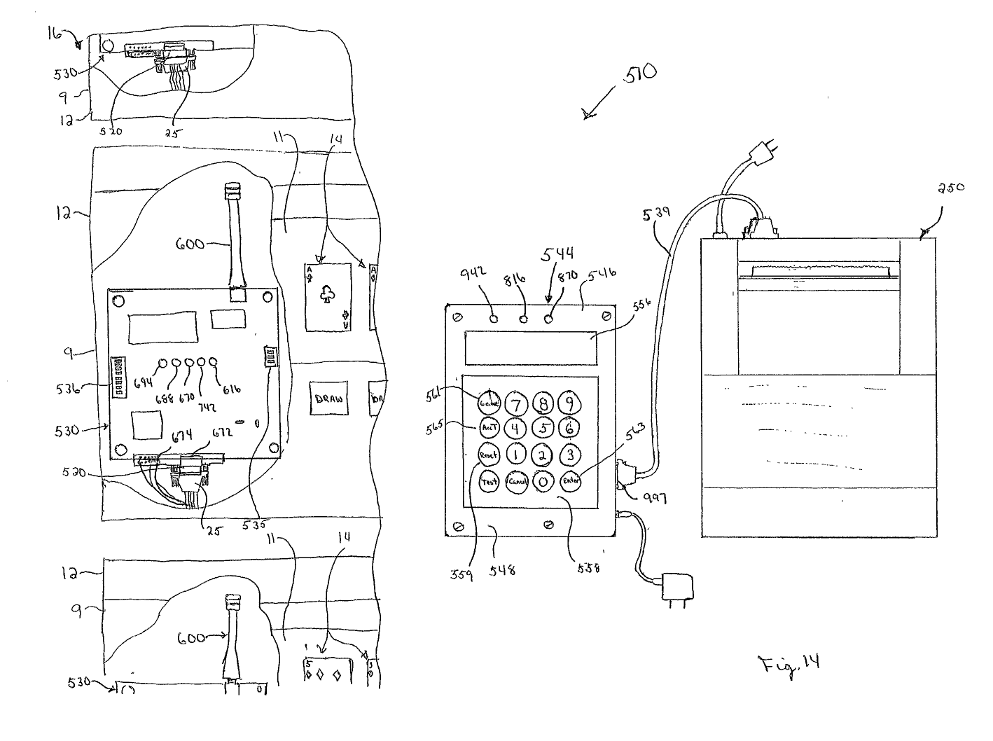

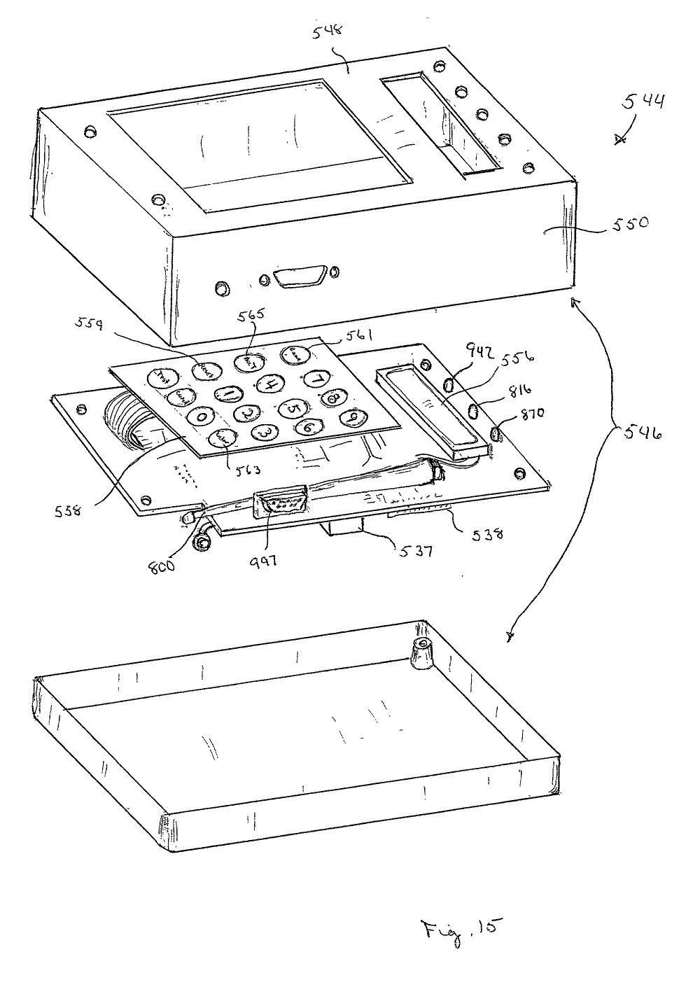

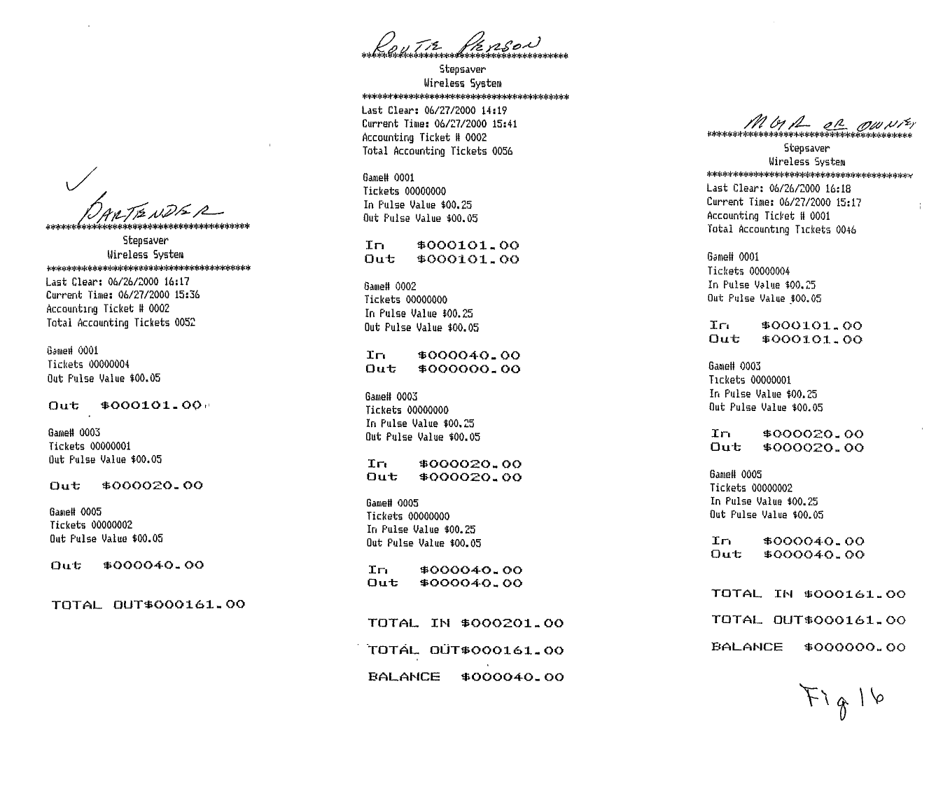

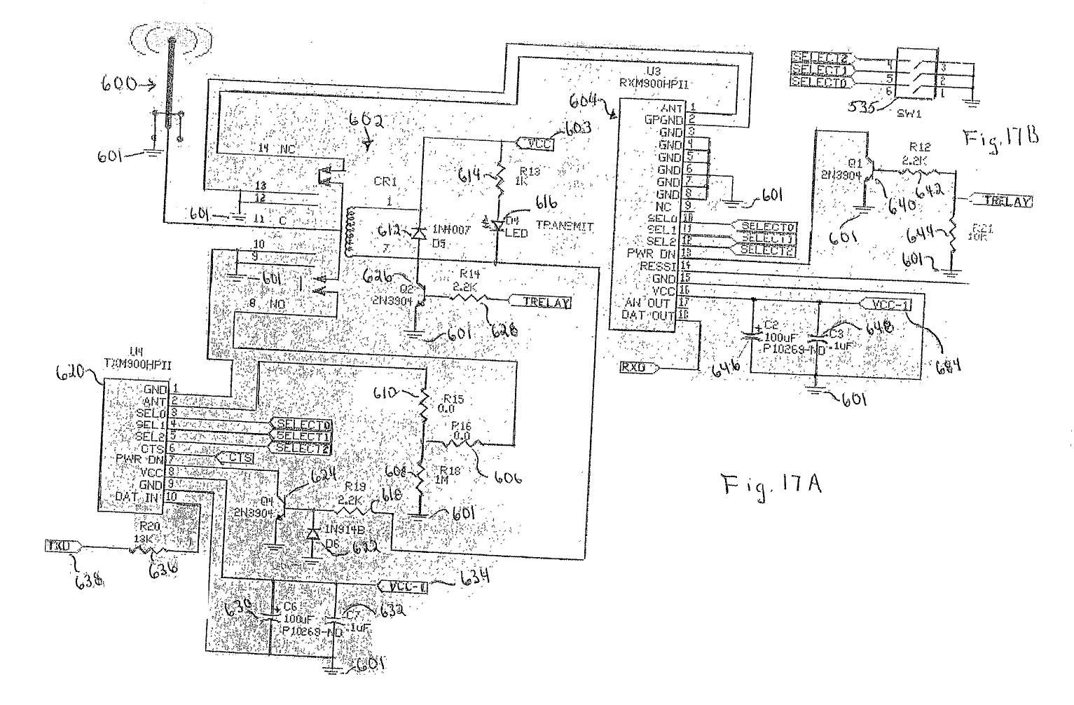

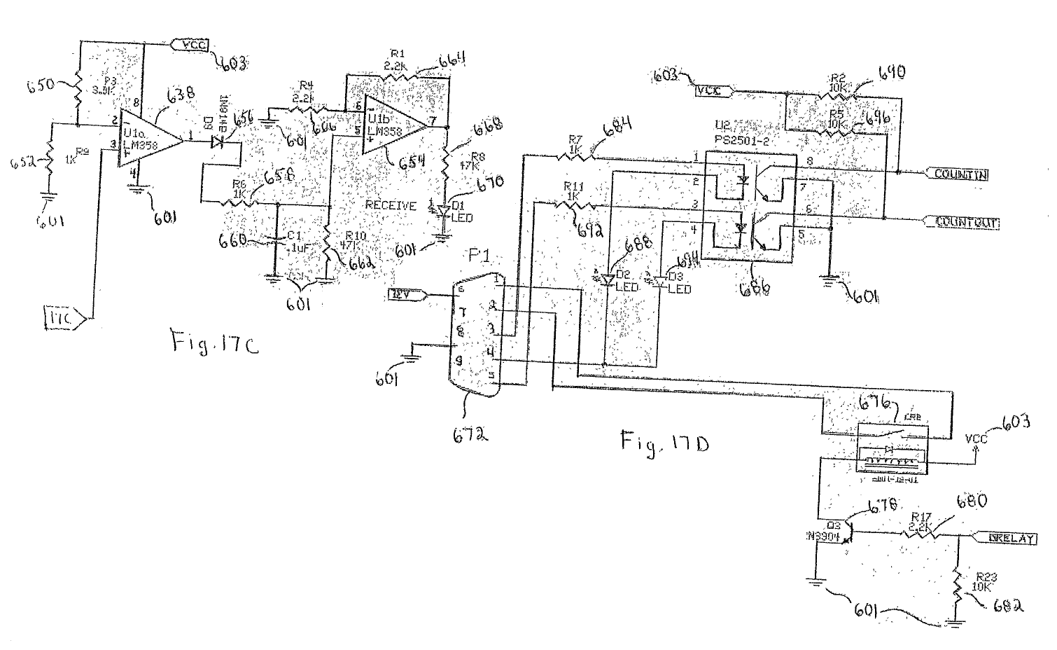

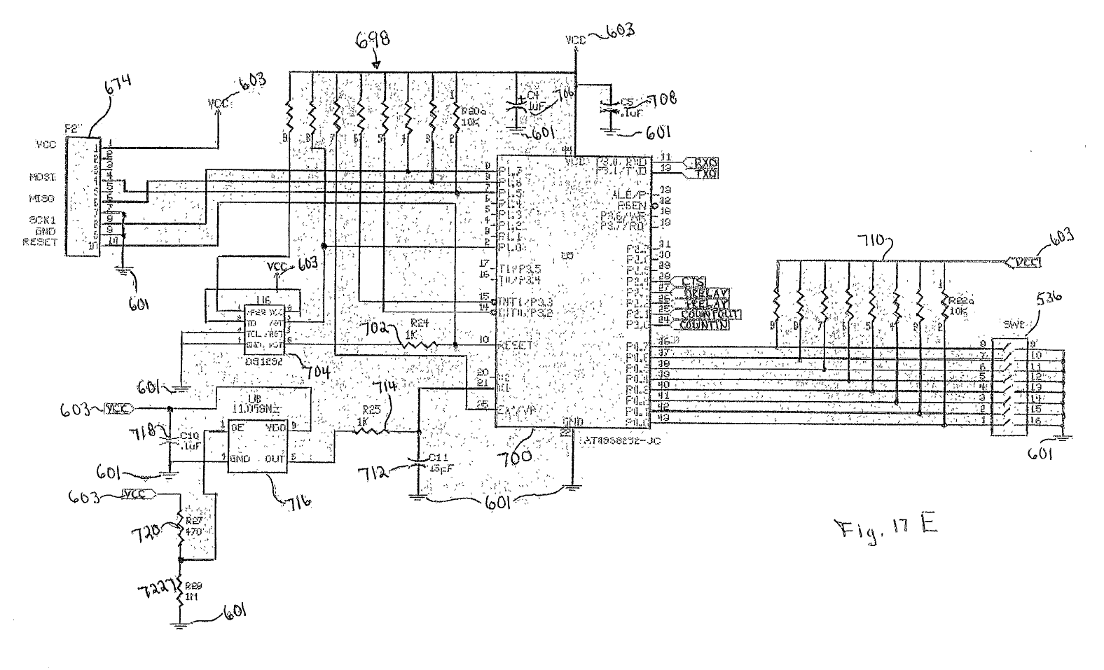

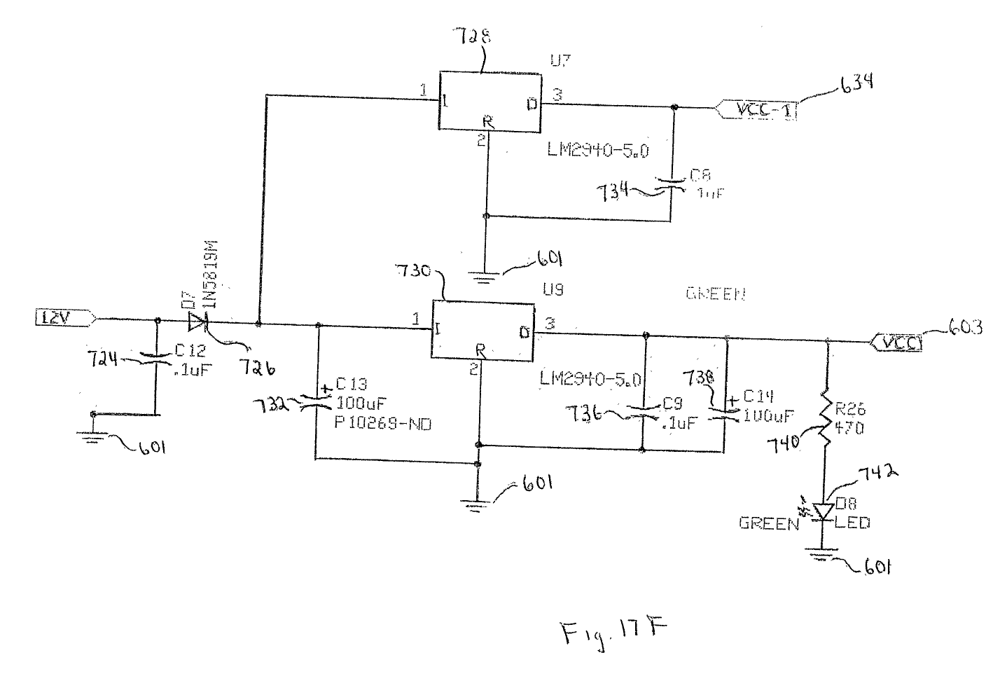

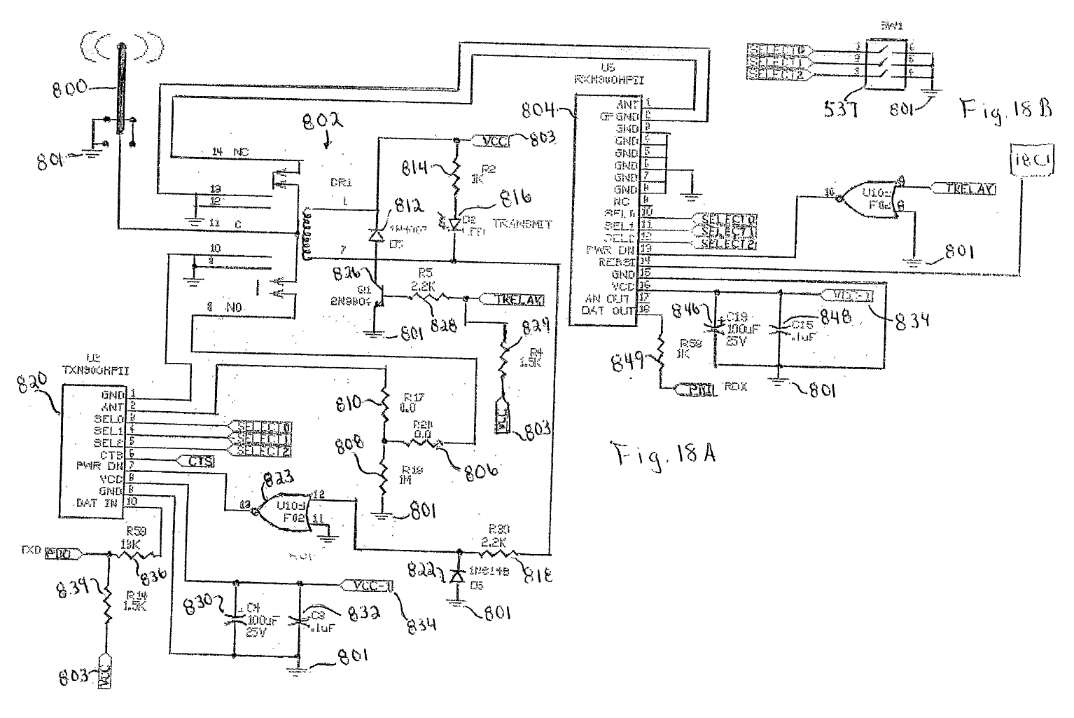

A game credit controller 510 in accordance with another aspect of the invention is shown in FIGS. 13-18. As shown for example, in FIG. 13, a plurality of gaming machines 12 (six of which are illustrated in FIG. 13 and three of which are illustrated in FIG. 14) are each provided with a pulse control unit 530 in communication with a credit controller 544. The credit controller 544 is also in communication through printer cable 539 with a printer 250. Each pulse collection unit 530 and controller 544 include a transceiver 534, 538 respectively and rubber duck antennas to communicate over one of eight selectable channels in the 900 MHZ band. Each transceiver 534, 538 within an establishment with less than 256 gaming machines is set to the same channel by a three position top slide DIP switch 535, 537 respectively. In an establishment with more than 256 gaming machines 12, separate banks of gaming machines may be controlled by separate credit controllers 544 with the credit controllers 544 and pulse collection units in each bank set to the same distinct channel. Channel selection also allows the game credit controller 510 to be moved around to frequencies that do not interfere with remote telephones, walkie-talkies, and other devices using the 900 MHZ band that may exist in the facility.

As will be described later, illustrated game credit controller 510 is designed to control 256 different gaming machines by providing each pulse collection unit 530 with an I.D. tag through setting switches on an 8 position top slide DIP switch 536. Although described as controlling 256 different gaming machines, and illustrated as controlling six or three machines in FIGS. 13 and 14 respectively, those skilled in the art will recognize that it is within the scope of the invention to control more or less gaming machines 12 with game controller 510. Also, while gaming machines 12 are illustrated as video poker machines, it should be understood that the term gaming machines, as used herein includes entertainment devices which accumulate credits based on the receipt of tokens or money such as video poker machines, slot machines, juke boxes, and the like.

As shown in FIGS. 13 and 14, a game-credit control apparatus 510 in accordance with the present invention is designed to remove and transfer game credits from gaming machines 12 to a credit controller 544 positioned in a location remote from gaming machines 12. Control apparatus 510 is situated in an establishment (not shown) remote from gaming machines 12. Control apparatus 510 is suited for use with gaming machines 12 that are capable of receiving tokens and coins of various values as well as cards that contain various credit values. Although one gaming machine 12 will be discussed hereafter, it is understood that the discussion applies to each gaming machine 12.

Gaming machine 12 is a representative video poker machine provided with a cabinet 9 having a video screen 11 and displaying a plurality of visual displays 14 that interact with the player's input and display the number of credits that the player has accumulated. Control apparatus 510 in accordance with the present invention is equally appropriate for use with video slot machines, juke boxes, and the like. Control apparatus 510 may also be used with other types of entertainment devices that store credits based upon the number of credits the users supply to gaming machine 12 and upon the outcome of the games played.

As shown, for example, in FIG. 13, gaming machine 12 has a game board 17 within the cabinet 9, a game harness 25 that cooperates with game board 17, a gaming-machine counter harness 21, a gaming-machine in-counter 13, and a gaming-machine out-counter 15. Game board 17 is powered by gaming machine 12 and transfers the total number of credits purchased by the player as well as the amount of credits the player has won or lost to game harness 25 and to gaming-machine counter harness 21. Gaming-machine counter harness 21 is in communication with gaming-machine in-counter 13 and a gaming-machine out-counter 15.

As shown in FIG. 13, gaming machine 12 also includes an external reset push-button switch 19, or has two external wing nuts (not shown) that are in communication with game board 17 and are connected to allow clearing of the current credit totals from gaming machine 12. Credit totals are cleared from gaming machine 12 either by pressing push-button switch 19 or by touching both wing nuts (not shown) with a coin or other metal object. Also connected to game harness 25 are a system ground 23 and a reset signal via wire 33. In normal operation, game harness 25 is configured to receive an input counter signal indicating the amount of credit purchased for game via a wire 27. Once the player has finished playing gaming machine 12, gaming machine receives a signal via a wire 29 indicating the total amount of credits cashed-in. In addition, gaming machine has a twelve volt power line 31.

Control apparatus 510 of the present invention exploits power line 31, system ground 23, and the signals conveyed by wires 27, 29, 33 that are present on game board 17 to remove and transfer game credits to a remote location. To exploit game board 17, it is necessary to first connect system ground 23 to reset push-button switch 19. In addition, gaming machine counter harness 21 is disconnected from in and out counters 13, 15 because control apparatus 10 eliminates the need for in-counters 13 and out-counters 15 mounted on gaming machine 12. Although game boards 17 and game harnesses 25 have been described herein, it is understood that a wide variety of game boards and game harness that are commercially available and are well known within the gaming device industry are suitable for use with the present invention.

Control apparatus 510 of the present invention exploits game board 17, power line 31, system ground 23, and signals 27, 29, and 33 from gaming machine 12 by connecting game harness 520 to game harness 25 to remove game credits from gaming machines 12 to transfer the calculated game credit totals. As shown in FIGS. 13 and 14, control apparatus 510 includes a pulse collection unit 530, a credit controller 544, and a printer 250. Each gaming machine 12 is provided with a pulse control unit 530. Pulse control unit 530 is coupled through game harness 520 to game harness 25 to communicate with game board 17 gaming machine 12 and is in electronic communication through a transceiver 534 with a transceiver 538 of credit controller 544.

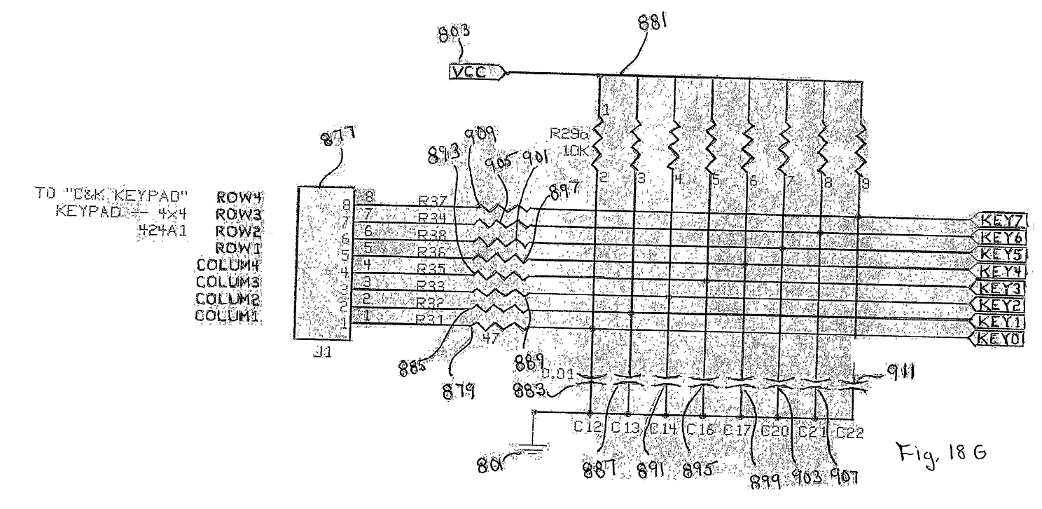

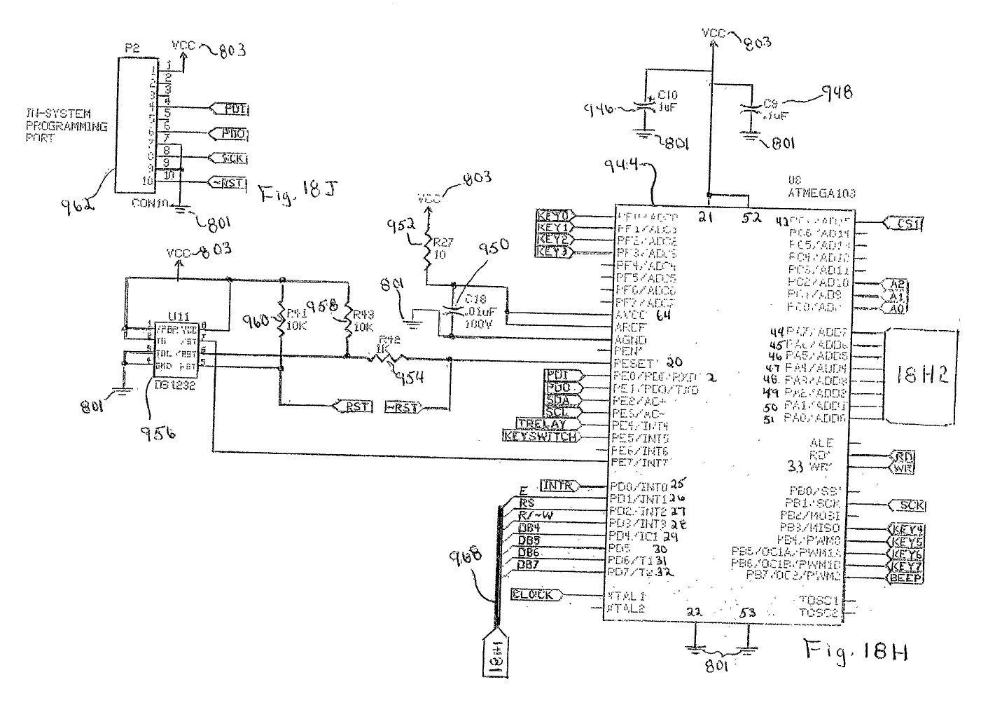

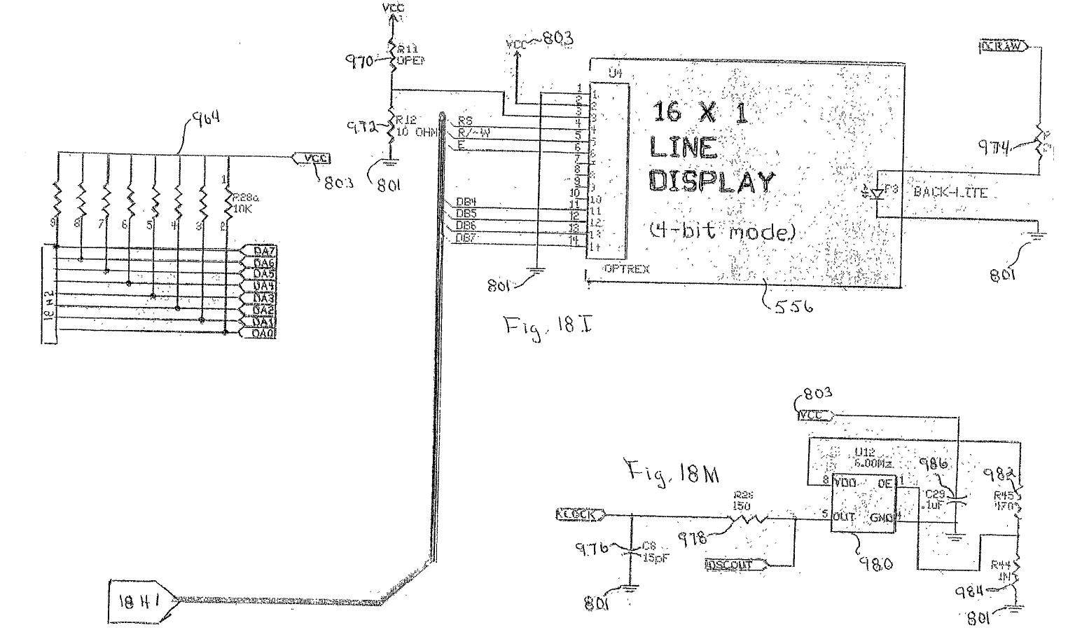

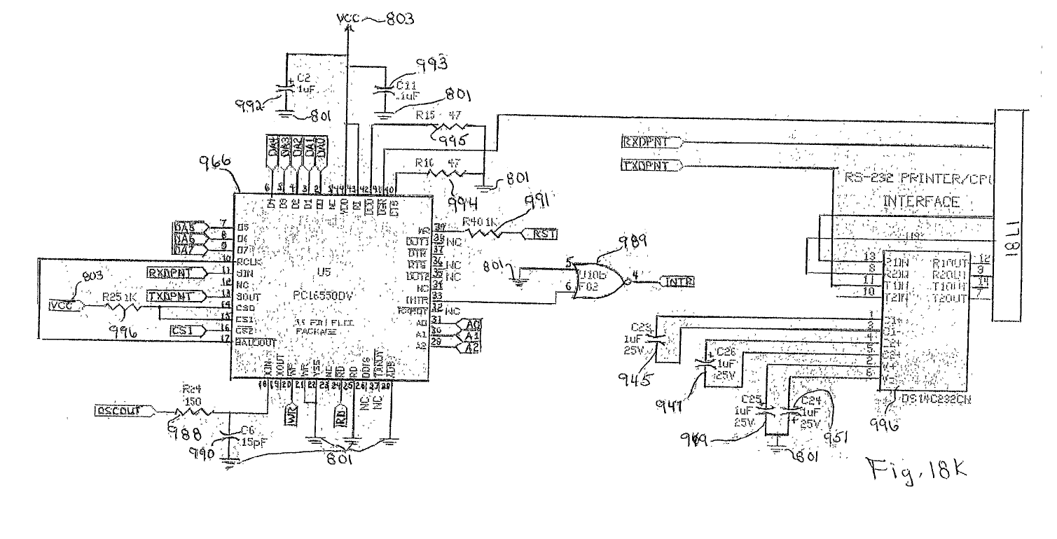

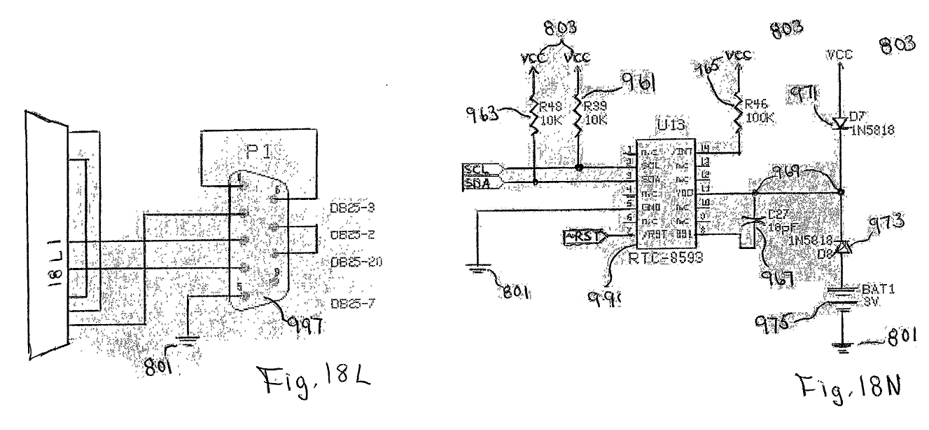

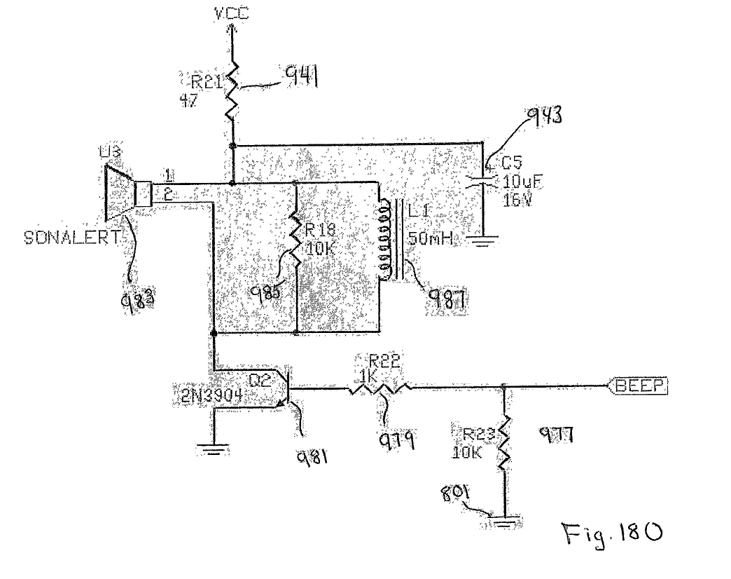

FIGS. 17A-F are a schematic diagram of pulse collector unit 530 and FIGS. 18A-O are a schematic of controller 544. In describing the schematics of pulse collector unit 530 and controller 544, pin numbers of multiple pin components will be enclosed in parenthesis (eg. Pin (2)) to distinguish pin numbers from reference numerals.

FIGS. 17A-C illustrate transceiver 534. Pulse collector unit 530 transmits and receives data from game controller 544 through antenna 600 which is coupled at one lead to ground 601 and at another lead to the center tap of a PC mounted Single Pole Double Throw (SPDT) Hi-frequency relay 602. Illustratively, antenna 600 is a rubber duck type antenna mounted to a 0.200′ right angle gold PC mountable connector manufactured by Johnson as Part No. 142-0701-301.

As shown for example in FIG. 17A, pins (9), (10), (12) and (13) of SPDT Hi-frequency relay 602 are coupled to ground 601. Pins (12) and (13) of SPDT Hi-frequency relay 602 are also coupled to the GPGND pin (2) the 900 MHZ receiver 604 forming one half of transceiver 534. Pins (9) and (10) of SPDT Hi-frequency relay 602 are also coupled to the GND pin (1) of the 900 MHZ transmitter 620 forming the other half of transceiver 534. The normally-closed switch pin (14) of SPDT Hi-frequency relay 602 is coupled to the antenna pin (1) receiver 604. The normally-open switch pin (8) of SPDT Hi-frequency relay 602 is coupled through resistor 606 to a voltage divider formed by resistors 608 and 610 and through the voltage divider to GND pin (1) of transmitter 620. The first lead pin (1) of the electromagnet of SPDT Hi-frequency relay 602 is coupled to V_{CC} 603, the cathode of diode 612 and to a first lead of resistor 614 which is coupled at its second lead to the anode of light emitting diode (LED) 616. The anode of diode 612 is coupled to the collector of transistor 626 which is coupled at its emitter to ground 601 and at its base to resistor 628 which is coupled to P2.2pin (26) of micro-controller 700. The second lead pin (7) of the electromagnet of SPDT Hi-frequency relay 602 is coupled to the cathode of LED 616 and one lead of resistor 618 which is indirectly coupled at its second lead to the power down PWR DN pin (7) of transmitter 620. The second lead of resistor 618 is coupled to the cathode of diode 622 which is coupled at its anode to ground 601 and to the base of transistor 624 which is coupled at its emitter to ground 601 and at its collector to PWR DN pin (7) of transmitter 620.

The illustrated PC mounted SPDT Hi-frequency relay 602 is available from Omron as Part No. G5Y-1-DC5. The illustrated resistors 606 and 610 are each ⅛ watt 5% carbon film zero Ohm resistors available from Panasonic as Part No. ERJ-8GEY0R00V. Resistor 614 is a ¼ Watt 5% carbon film 1.0 Kilo-Ohm resistor available from Yageo as Part No. CFR-25JB 1K0. Resistor 608 is a 1/4 Watt 5% carbon film 1.0 Mega-Ohm resistor available from Yageo as Part No. CFR-25JB 1M0. Resistor 618 and 628 are ¼ Watt 5% carbon film 2.2 Kilo-Ohm resistor available from Yageo as Part No. CFR-25JB 2K2. Diode 612 is a 1 amp 1000 Volt glass diode available from Vishay as Part No. IN40007G. Diode 622 is a 100 Volt 500 Mega-Watt Fast switching diode available from Vishay as Part No. IN4148. LED 616 is a 5 mm green diffused diode available from Lite-On as Part No. 4233 and is used to indicate that pulse collector Unit 530 is transmitting information to controller 544. Transistors 624 and 626 are 40 volt NPN transistors available from Vishay as Part No. 2N3904D1.

As previously mentioned transmitter 620 is designed to transmit on one of eight channels in the 900 MHz band. Channel selection is made by toggling the three switches on DIP switch 535 (See FIG. 17B) into one of their eight possible configurations. As shown in FIGS. 17A and B, Pins (1-3) of DIP switch 535 are coupled to ground 601 while pins (4-6) are coupled to channel selection pins (3-5) of transmitter 620. Clear to Send (“CTS”) pin (6) of transmitter 620 is coupled to P2.4 pin (29) of micro-controller 700. V_{CC} Pin (8) of transmitter 620 is coupled to the cathodes of capacitors 630, 632 and V_{CC}−1 (634). Digital ground GND pin (9) is connected to the anodes of capacitors 630, 632 and ground 601. DAT IN pin (10) of transmitter 620 is coupled through resistor 636 to P3.1/TXD pin (19) of micro-controller 700.

Illustratively, transmitter 620 is an HP Series-II FM transmitter module capable of transmitting analog or digital data in the 900 MHZ band. Transmitter 620 is available from Linx Technologies, Inc., 575 S.E. Ashley Place, Grant Pass, Oreg., as Part No. TXM-900-HP-II. Illustratively capacitor 630 is a 100 microfarad 25 volt electrolytic FC radial capacitor available from Panasonic as Part No. EEU-FC1E101S. Capacitor 632 is a 0.1 microfarad 50 volt 20% mono ceramic capacitor available from Panasonic as Part No. ECU-S1H104MEA. Resistor 636 is actually a resistive network 10 kilo-ohm nine element resistive network calibrated to 13 kilo-ohms available from Panasonic as Part No. EXB-F10E103G.

Receiver 604 is designed to receive on one of eight channels in the 900 MHZ band. Channel selection is made by toggling the three switches on DIP switch 535 (See FIG. 17B) into one of their eight possible configurations. As shown in FIGS. 17A and B, Pins (1-3) of DIP switch 535 are coupled to ground 601 while pins (4-6) are coupled to channel selection pins (10-12) respectively of receiver 604. Thus, in the illustrated embodiment, the channel selected for transmitter 620 and receiver 604 are the same channel allowing transmitter 620 and receiver 604 to be referred to collectively as transceiver 534. Pins (3-8)of receiver 604 are coupled to ground 601. Received Signal Strength Indicator (“RESSI”) pin (14) of receiver 604 is coupled to the non-inverting input of operational amplifier 638 (see FIG. 17C). The PWR DN pin (13) of receiver 604 is coupled to the collector of transistor 640 which has its emitter coupled to ground 601 and its base coupled through a voltage divider formed from resistors 642 and 643 to ground 601 and to P2.2 pin (26) of micro-controller 700. V_{CC} Pin (16) of receiver 604 is coupled to the cathodes of capacitors 646, 648 and V_{CC}−1 (634). Digital ground GND pin (15) of receiver 604 is connected to the anodes of capacitors 646, 648 and ground 601. Data Out (“DAT OUT”) pin (18) is coupled to P3.0/RXD pin (11) of micro-controller 700. Pin (9) and analog data out (“AN OUT”) pin (17) have no connections in the illustrated embodiment.

Illustratively, receiver 604 is an HP Series-II FM receiver module capable of receiving analog or digital data in the 900 MHZ band. Receiver 604 is available from Linx Technologies, Inc., 575 S.E. Ashley Place, Grant Pass, Oreg., as Part No. RXM-900-HP-II. Illustratively capacitor 646 is a 100 microfarad 25 volt electrolytic FC radial capacitor available from Panasonic as Part No. EEU-FC1E101S. Capacitor 648 is a 0.1 microfarad 50 volt 20% mono ceramic capacitor available from Panasonic as Part No. ECU-S1H104MEA. Transistor 640 is a 40 volt NPN transistors available from Vishay as Part No. 2N3904DI. Resistor 642 is a ¼ Watt 5% carbon film 2.2 Kilo-Ohm resistor available from Yageo as Part No. CFR-25JB 2K2. Resistor 644 is a 10 kilo-ohm ¼ watt 5% carbon film resistor available from Yageo as Part No. CFR-25JB 10K.

Referring to FIG. 17C, inverting input pin (2) of operational amplifier 638 is coupled to a first lead of resistor 650 and the first lead of resistor 652. The second lead of resistor 650 is coupled to V_{CC} 603 and to _{the VCC} pin (8) of the dual in-line pin integrated circuit containing operational amplifiers 638 and 654. The second lead of resistor 652 is coupled to ground 601. GND pin (4) of the dual in-line pin integrated circuit containing operational amplifiers 638 and 654 is coupled to ground 601. The output pin (1) of operational amplifier 638 is coupled to the anode of diode 656 which is coupled at its cathode to the first lead of resistor 658. The second lead of resistor 658 is coupled to the first leads of capacitor 660 and resistor 662 and to the non-inverting input pin (5) of operational amplifier 654. The second leads of capacitor 660 and resistor 662 are coupled to ground 601. The inverting input pin (6) of operational amplifier 654 is coupled through feedback resistor 664 to the output pin (7) of operational amplifier 654 and through resistor 666 to ground 601. Output pin (7) of operational amplifier 654 is also coupled through resistor 668 to the anode of LED 670 which is coupled at its cathode to ground 601.

Illustratively, operational amplifiers 638 and 654 are contained on an Integrated circuit low power dual Op Amp in an eight pin DIP package available from National Semiconductor as Part No. LM358AN. Resistor 650 is a ¼ Watt 5% carbon film 3.9 Kilo-Ohm resistor available from Yageo as Part No. CFR-25JB 3K9. Resistors 652 and 658 are ¼ Watt 5% carbon film 1.0 Kilo-Ohm resistors available from Yageo as Part No. CFR-25JB 1K0. Resistors 662 and 668 are ¼ Watt 5% carbon film 47 Kilo-Ohm resistors available from Yageo as Part No. CFR-25JB 47K. Resistor 664 and 666 are ¼ Watt 5% carbon film 2.2 Kilo-Ohm resistor available from Yageo as Part No. CFR-25JB 2K2. Diode 656 is a 100 Volt 500 Mega-Watt Fast switching diode available from Vishay as Part No. IN4148. LED 670 is a 5 mm green diffused diode available from Lite-On as Part No. 4233 and is used to indicate that pulse collector Unit 530 is receiving information from controller 544. Capacitor 660 is a 0.1 microfarad 50 volt 20% mono ceramic capacitor available from Panasonic as Part No. ECU-S1H104MEA.

Referring to FIG. 17D, connector 672 is provided forming a portion of game harness 520 for connection to game harness 25 of gaming machine 12. The remainder of game harness 520 is described hereafter with regard to connector 674 illustrated in FIG. 17E. Connector 670 is a standard D-shell nine pin female connector available from such sources as Altex as Part No. DPRM-9S-HS. Pins (6) and (9) of connector 672 are coupled to the onboard power supply (see FIG. 17F) and ground 601 respectively. When coupled to game harness 25, Pins (6) and (9) are coupled to wires 31 and 23 providing the 12 volt power supply and ground to gaming machine 12 respectively. Pin (1) of connector 672 is coupled to a first switch pin of Relay 676 which is coupled at its other switch pin to pin (2) of connector 672. The two electromagnet pins of relay 676 are coupled to V_{CC} 603 and the collector of transistor 678 respectively. The emitter of transistor 678 is coupled to ground 601 while the base of transistor 678 is coupled through a voltage divider including resistors 680 and 682 to ground 601 and P2.3 pin (27) of micro-controller 700. Illustratively, relay 676 is a single pole single throw 5 volt single in-line pin reed relay with diode available from Hamlin as Part No. HE3621A0510. Transistor 678 is a 40 volt NPN transistors available from Vishay as Part No. 2N3904DI. Resistor 680 is a ¼ Watt 5% carbon film 2.2 Kilo-Ohm resistor available from Yageo as Part No. CFR-25JB 2K2. Resistor 682 is a ¼ Watt 5% carbon film 10 Kilo-Ohm resistor available from Yageo as Part No. CFR-25JB 10K.

Pin (3) of connector 672 is coupled through resistor 684 to LED anode base pin (1) of the first channel of two-channel opto-coupler transistor 686. When connector 672 is coupled to game harness 25, pin (3) is coupled to wire 27 carrying the input counter signal. LED cathode base pin (2) of the first channel of two-channel opto-coupler transistor 686 is coupled to the anode of LED 688 to pin (4) of connector 672. When connector 672 is coupled to game harness 25, pin (4) is coupled to wire 23 or system ground of the gaming machine 12. Collector pin (8) of the first channel of two-channel opto-coupler transistor 686 is connected to P2.0 pin (24) of micro-controller 700 and through resistor 690 to V_{CC} 603. Emitter pin (7) of the first channel of two-channel opto-coupler transistor 686 is coupled to ground 601. Thus LED 688 is lit as count in information is received from gaming machine 12.

Pin (5) of connector 672 is coupled through resistor 692 to LED anode base pin (3) of the second channel of two-channel opto-coupler transistor 686. When connector 672 is coupled to game harness 25, pin (5) is coupled to wire 29 carrying the total credits cashed in or count out signal. LED cathode base pin (4) of the second channel of two-channel opto-coupler transistor 686 is coupled to the anode of LED 694 to pin (4) of connector 672. When connector 672 is coupled to game harness 25, pin (4) is coupled to wire 23 or system ground of the gaming machine 12. Collector pin (6) of the second channel of two-channel opto-coupler transistor 686 is connected to P2.1 pin (25) of micro-controller 700 and through resistor 696 to V_{CC} 603. Emitter pin (5) of the second channel of two-channel opto-coupler transistor 686 is coupled to ground 601. Thus LED 694 is lit as count out information is received from gaming machine 12.

Illustratively, two-channel opto-coupler transistor 686 is available from NEC as Part No. PS2501-2. Resistors 684 and 692 are 0.1 microfarad 50 volt 20% mono ceramic capacitor available from Panasonic as Part No. ECU-S1H104MEA. LEDs 688 and 694 are 5 mm green diffused diodes available from Lite-On as Part No. 4233.

Referring to FIG. 17E, connector 674 forming the second part of game harness 520 is shown. Connector 674 is illustratively a shrouded straight ten-pin header available from 3M as Part No. 2510-6002UB. Pin (1) of connector 674 is coupled to V_{CC} and pins (7) and (9) are coupled to ground 601. Pin (4) of connector 674 is coupled to pin (2) of 10 Kilo-ohm resistive nine element network element 698 and to P1.5 pin (7) of an 8-bit micro-controller with 8 Kilobytes of flash memory 700. The illustrated resistive network 698 is available from Panasonic as Part No. EXB-F10E103G. The illustrated micro-controller 700 is available from Atmel as Part No. AT89S8252-24JC. Pin (6) of connector 674 is coupled to pin (3) of resistive element 698 and P1.6 pin (8) of micro-controller 700. Pin (8) of connector 674 is coupled to pin (4) of resistive element 698 and to P1.7 pin (9) of micro-controller 700. Pin (10) of connector 674 is coupled to reset pin (10) of micro-controller 700 and through resistor 702 to pin (5) of CPU supervisor 704. Resistor 702 is illustratively a ¼ Watt 5% carbon film 1.0 Kilo-Ohm resistors available from Yageo as Part No. CFR-25JB 1K0. CPU supervisor 704 is available from Dallas Semiconductors as Part No. DS1232N. When coupled to game harness 25, pin (10) of connector 674 is coupled to reset signal wire 33 of gaming machine 12, pin (9) of connector 674 is coupled ground wire 23 of gaming machine 12, and pin (1) of connector 674 is coupled to 12 volt power line 31 of gaming machine 12.

The first lead of each resistor in resistive element 698 is coupled through capacitor 706 to ground 60, through capacitor 708 to ground, to V_{CC} 603, and to V_{CC} pin 44 of micro-controller 700. Illustrated capacitor 706 is a 1.0 microfarad 35 volt DC Tantalum capacitor available from Panasonic as Part No. ECS-F1VE105K. Capacitor 708 is a 0.1 microfarad 50 volt 20% mono ceramic capacitor available from Panasonic as Part No. ECU-S1H104MEA.

/Per pin (1) of CPU supervisor 704 is coupled to pin (9) of resistive element 698. TD pin (2) of CPU supervisor 704 is coupled to V_{CC} 603 and to V_{CC} pin (8) of CPU supervisor 704. TDL pin (3) and GND pin (4) of CPU supervisor 704 are coupled to ground 601./ST pin (8) of CPU supervisor is coupled to pin (8) of resistive element 698 and to P1.0 pin of micro-controller 700.

GND pin (22) of micro-controller 700 is coupled to ground 601. P1.0-P1.4 pins (2-6), T1/P3.5 pin (17), To/P3.4 pin (16) X2 pin (20), P2.5-P2.7 pins (29-31), P3.6/WR′ and P3.7/RD′ pins (18 and 19), PSEN pin (32) and ALE/P′ pin (39) of micro-controller 700 have no connections in the illustrated embodiment.

P0.0-P0.7 pins (43, 42, 41, 40, 39, 38, 37, and 36) are coupled to pins (2-9) of resistive element and pins (1-8) of DIP switch 536 which has its pins (9-16) coupled to ground 601. Dip Switch 536 allows the user to enter an eight bit I.D. Tag number for the gaming machine 12 into which pulse collector unit 530 is installed which is recognized by micro-controller 700 and used to determine when a command sent by the controller 544 is intended to be executed by the machine. Commands not containing the ID tag for the machine in which the pulse collector unit is installed are ignored by micro-controller 700. Illustratively, resistive element 710 is a 10 Kilo-ohm resistive nine element network element available from Panasonic as Part No. EXB-F10E103G. Dip switch 536 is an eight position top slide Dip switch available from C and K as Part No. BD08.

X1 pin (21) of micro-controller 700 is coupled through capacitor 712 to ground and through resistor 714 to OUT pin (5) of oscillator 716 which provides a clock signal to micro-controller 700. V_{DD} Pin (8) of Oscillator 716 is coupled to V_{CC} 603 and through capacitor 718 to GND pin (4) of oscillator 716 and to ground 601. OE pin (1) of Oscillator 716 is coupled through a voltage divider formed by resistors 720 and 722 to V_{CC} 603 and ground 601 respectively. Illustratively, oscillator 716 is an 11.059 MHZ CMOS Crystal oscillator in an eight DIP package available from Epson as Part No. SG-531P-11.059MC. Capacitor 712 is a 15 picofarad 100 volt 5% monolithic ceramic capacitor available from Panasonic as Part No. ECU-S2A150JCA. Capacitor 718 is a 0.1 microfarad 50 volt 20% mono ceramic capacitor available from Panasonic as Part No. ECU-S1H104MEA. Resistor 714 is a ¼ Watt 5% carbon film 1.0 Kilo-Ohm resistor available from Yageo as Part No. CFR-25JB 1K0. Resistor 720 is a ¼ Watt 5% carbon film 470 Ohm resistor available from Yageo as Part No. CFR-25JB 470R. Resistor 722 is a ¼ Watt 5% carbon film 1.0 Mega-Ohm resistor available from Yageo as Part No. CFR-25JB 1M0.

The 12 V supply entering pulse collection unit 530 through game harness 520 is coupled through capacitor 724 to ground 601 and to the anode of diode 726, as shown for example in FIG. 17F. The cathode of diode 726 is coupled to pin (1) of voltage regulator 728, to pin (1) of voltage regulator 730, and through capacitor 732 to ground. Pin (2) of voltage regulator 728 is coupled to ground 601 and through capacitor 734 to pin (3) of voltage regulator 728. At the node where capacitor 734 is coupled to pin (3) of voltage regulator 728 V_{CC}−1 potential relative to ground 601 is present. Pin (2) of voltage regulator 730 is coupled to ground 601 and through parallel capacitors 736 and 738 to pin (3) of voltage regulator 728. At the node where capacitor 738 is coupled to pin (3) of voltage regulator 730, pin (3) of voltage regulator and capacitor 738 are coupled through resistor 740 and LED 742 to ground 601. Thus LED 742 is lit when power is present in pulse collection unit 530. At this node V_{CC} 603 potential relative to ground 601 is present. Illustratively, Capacitors 712, 734, and 736 are 0.1 microfarad 50 volt 20% mono ceramic capacitors available from Panasonic as Part No. ECU-S1H104MEA. Capacitors 732 and 738 are is a 100 microfarad 25 volt electrolytic FC radial capacitor available from Panasonic as Part No. EEU-FC1E101S. Resistor 740 is a ¼ Watt 5% carbon film 470 Ohm resistor available from Yageo as Part No. CFR-25JB 470R. Diode 726 is a 1 amp 40 PIV schottky barrier rectifier available from General Semiconductor as Part No. IN5819. LED 742 is a 5 mm green diffused diode available from Lite-On as Part No. 4233. Illustratively voltage regulators 728 and 730 are 1 amp low drop-out 5.0 volt regulators available from National Semiconductor as Part No. LM2940CT-5.0

FIGS. 18A-C illustrate transceiver 538. Credit controller 544 transmits and receives data from game controller 544 through antenna 800 which is coupled at one lead to ground 801 and at another lead to the center tap of a PC mounted Single Pole Double Throw (SPDT) Hi-frequency relay 802. Illustratively, antenna 800 is a rubber duck type antenna mounted to a 0.200″ right angle gold PC mountable connector manufactured by Johnson as Part No. 142-0701-301.

As shown for example in FIG. 18A, pins (9), (10), (12) and (13) of SPDT Hi-frequency relay 802 are coupled to ground 801. Pins (12) and (13) of SPDT Hi-frequency relay 602 are also coupled to the GPGND pin (2) the 900 MHZ receiver 804 forming one half of transceiver 538. Pins (9) and (10) of SPDT Hi-frequency relay 802 are also coupled to the GND pin (1) of the 900 MHZ transmitter 820 forming the other half of transceiver 538. The normally-closed switch pin (14) of SPDT Hi-frequency relay 802 is coupled to the antenna pin (1) receiver 804. The normally-open switch pin (8) of SPDT Hi-frequency relay 802 is coupled through resistor 806 to a voltage divider formed by resistors 808 and 810 and through the voltage divider to GND pin (1) of transmitter 820. The first lead pin (1) of the electromagnet of SPDT Hi-frequency relay 802 is coupled to V_{CC} 803, the cathode of diode 812 and to a first lead of resistor 814 which is coupled at its second lead to the anode of light emitting diode (LED) 816. The anode of diode 812 is coupled to the collector of transistor 826 which is coupled at its emitter to ground 801 and at its base to resistor 828 which is coupled to PE4/INT4 pin (6) of micro-controller 944 and through resistor 829 to ground 801. The second lead pin (7) of the electromagnet of SPDT Hi-frequency relay 802 is coupled to the cathode of LED 816 and one lead of resistor 818 which is indirectly coupled at its second lead to the power down PWR DN pin (7) of transmitter 820. The second lead of resistor 818 is coupled to the cathode of diode 822 which is coupled at its anode to ground 801 and to first input pin (12) of NOR gate 823 which is coupled at its second input to ground 801 and at its output to PWR DN pin (7) of transmitter 820.

The illustrated PC mounted SPDT Hi-frequency relay 802 is available from Omron as Part No. G5Y-1-DC5. The illustrated resistors 806 and 810 are each ⅛ watt 5% carbon film zero Ohm resistors available from Panasonic as Part No. ERJ-8GEY0R00V. Resistor 814 is a ¼ Watt 5% carbon film 1.0 Kilo-Ohm resistor available from Yageo as Part No. CFR-25JB 1K0. Resistor 808 is a 1/4 Watt 5% carbon film 1.0 Mega-Ohm resistor available from Yageo as Part No. CFR-25JB 1M0. Resistor 818 and 828 are ¼ Watt 5% carbon film 2.2 Kilo-Ohm resistor available from Yageo as Part No. CFR-25JB 2K2. Resistor 829 is a ¼ Watt 5% carbon film 1.5 Kilo-Ohm resistor available from Yageo as Part No. CFR-2531B 1K5. Diode 812 is a 1 amp 1000 Volt glass diode available from Vishay as Part No. IN40007G. Diode 822 is a 100 Volt 500 Mega-Watt Fast switching diode available from Vishay as Part No. IN4148. LED 816 is a 5 mm green diffused diode available from Lite-On as Part No. 4233 and is used to indicate that pulse collector Unit 530 is transmitting infonnation to controller 544. Transistor 826 is a 40 volt NPN transistor available from Vishay as Part No. 2N3904DI.

As previously mentioned transmitter 820 is designed to transmit on one of eight channels in the 900 MHz band. Channel selection is made by toggling the three switches on DIP switch 537 (See FIG. 18B) into one of their eight possible configurations. As shown in FIGS. 18A and B, Pins (1-3) of DIP switch 537 are coupled to ground 801 while pins (4-6) are coupled to channel selection pins (3-5) of transmitter 820. Clear to Send (“CTS”) pin (6) of transmitter 820 is coupled to CTS. V_{CC} Pin (8) of transmitter 820 is coupled to the cathodes of capacitors 830, 832 and V_{CC}−1 834. Digital ground GND pin (9) is connected to the anodes of capacitors 830, 832 and ground 801. DAT IN pin (10) of transmitter 820 is coupled through resistor 836 to both TXD and resistor 839 which is coupled to V_{CC} 803.

Illustratively, transmitter 820 is an HP Series-II FM transmitter module capable of transmitting analog or digital data in the 900 MHZ band. Transmitter 820 is available from Linx Technologies, Inc., 575 S.E. Ashley Place, Grant Pass, Oreg., as Part No. TXM-900-HP-II. Illustratively capacitor 830 is a 100 microfarad 25 volt electrolytic FC radial capacitor available from Panasonic as Part No. EEU-FC1E101S.

Capacitor 832 is a 0.1 microfarad 50 volt 20% mono ceramic capacitor available from Panasonic as Part No. ECU-S1H104MEA. Resistor 836 is a ¼ Watt 5% carbon film 13 Kilo-Ohm resistor available from Yageo as Part No. CFR-25JB13K. Resistor 839 is a ¼ Watt 5% carbon film 1.5 Kilo-Ohm resistor available from Yageo as Part No. CFR-25JB1K5.

Receiver 804 is designed to receive on one of eight channels in the 900 MHZ band. Channel selection is made by toggling the three switches on DIP switch 537 (See FIG. 18B) into one of their eight possible configurations. As shown in FIGS. 18A and B, Pins (1-3) of DIP switch 537 are coupled to ground 801 while pins (4-6) are coupled to channel selection pins (10-12) respectively of receiver 804. Thus, in the illustrated embodiment, the channel selected for transmitter 820 and receiver 804 are the same channel allowing transmitter 820 and receiver 804 to be referred to collectively as transceiver 538. Pins (3-8) of receiver 804 are coupled to ground 801. Received Signal Strength Indicator (“RESSI”) pin (14) of receiver 804 is coupled to the non-inverting input of operational amplifier 838 (see FIG. 18C). The PWR DN pin (13) of receiver 804 is coupled to the output pin (10) of NOR gate 841 which has one of its input pins (8) coupled to ground 801 and its other input pin (9) coupled to PE4/INT4 pin (6) of micro-controller 944. V_{CC} Pin (16) of receiver 804 is coupled to the cathodes of capacitors 846, 848 and V_{CC}−1 834. Digital ground GND pin (15) of receiver 804 is connected to the anodes of capacitors 846, 848 and ground 801. Data Out (“DAT OUT”) pin (18) is coupled through resistor 849 to PDI. Pin (9) and analog data out (“AN OUT”) pin (17) have no connections in the illustrated embodiment.

Illustratively, receiver 804 is an HP Series-II FM receiver module capable of receiving analog or digital data in the 900 MHZ band. Receiver 804 is available from Linx Technologies, Inc., 575 S.E. Ashley Place, Grant Pass, Oreg., as Part No. RXM-900-HP-II. Illustratively capacitor 846 is a 100 microfarad 25 volt electrolytic FC radial capacitor available from Panasonic as Part No. EEU-FC1E101S. Capacitor 848 is a 0.1 microfarad 50 volt 20% mono ceramic capacitor available from Panasonic as Part No. ECU-S1H104MEA. Resistor 849 is a ¼ Watt 5% carbon film 1.0 Kilo-Ohm resistor available from Yageo as Part No. CFR-25JB1K0.

Referring to FIG. 18C, inverting input pin (2) of operational amplifier 838 is coupled to a first lead of resistor 850 and the first lead of resistor 852. The second lead of resistor 850 is coupled to V_{CC} 803 and to V_{CC} pin (8) of the dual in-line pin integrated circuit containing operational amplifiers 838 and 854. The second lead of resistor 852 is coupled to ground 801. GND pin (4) of the dual in-line pin integrated circuit containing operational amplifiers 838 and 854 is coupled to ground 801. The output pin (1) of operational amplifier 838 is coupled to the anode of diode 856 which is coupled at its cathode to the first lead of resistor 858. The second lead of resistor 858 is coupled to the first leads of capacitor 860 and resistor 862 and to the non-inverting input pin (5) of operational amplifier 854. The second leads of capacitor 860 and resistor 862 are coupled to ground 801. The inverting input pin (6) of operational amplifier 854 is coupled through feedback resistor 864 to the output pin (7) of operational amplifier 854 and through resistor 866 to ground 801. Output pin (7) of operational amplifier 854 is also coupled through resistor 868 to the anode of LED 870 which is coupled at its cathode to ground 801.

Illustratively, operational amplifiers 838 and 854 are contained on an Integrated circuit low power dual Op Amp in an eight pin DIP package available from National Semiconductor as Part No. LM358AN. Resistor 850 is a ¼ Watt 5% carbon film 3.9 Kilo-Ohm resistor available from Yageo as Part No. CFR-25JB3K9. Resistor 858 is a ¼ Watt 5% carbon film 1.0 Kilo-Ohm resistors available from Yageo as Part No. CFR-25JB1K0. Resistors 862 and 868 are ¼ Watt 5% carbon film 47 Kilo-Ohm resistors available from Yageo as Part No. CFR-25JB47K. Resistors 852, 864 and 866 are ¼ Watt 5% carbon film 2.2 Kilo-Ohm resistor available from Yageo as Part No. CFR-25JB2K2. Diode 856 is a 100 Volt 500 Mega-Watt Fast switching diode available from Vishay as Part No. IN4148. LED 870 is a 5 mm green diffused diode available from Lite-On as Part No. 4233 and is used to indicate that controller 544 is receiving information from pulse collection unit 530. Capacitor 860 is a 0.1 microfarad 50 volt 20% mono ceramic capacitor available from Panasonic as Part No. ECU-S1H104MEA.

The 12 V supply entering credit controller 544 is coupled through capacitor 924 to ground 901 and to the anode of diode 926, as shown for example in FIG. 18D. The cathode of diode 926 is coupled to pin (1) of voltage regulator 928, through resistor 974 and diode of display 556 to ground 801 (See FIG. 18I), to pin (1) of voltage regulator 930, and through capacitor 932 to ground 801. Pin (2) of voltage regulator 928 is coupled to ground 901 and through capacitor 934 to pin (3) of voltage regulator 928. At the node where capacitor 934 is coupled to pin (3) of voltage regulator 928 V_{CC}−1 834 potential relative to ground 801 is present. Pin (2) of voltage regulator 830 is coupled to ground 801 and through parallel capacitors 836 and 838 to pin (3) of voltage regulator 928. At the node where capacitor 938 is coupled to pin (3) of voltage regulator 930, pin (3) of voltage regulator 930 and capacitor 938 are coupled through resistor 940 and LED 942 to ground 801. Thus LED 942 is lit when power is present in credit controller 544. At this node V_{CC} 803 potential relative to ground 801 is present. Illustratively, Capacitors 912, 934, and 936 are 0.1 microfarad 50 volt 20% mono ceramic capacitors available from Panasonic as Part No. ECU-S1H104MEA. Capacitors 932 and 938 are 100 microfarad 25 volt electrolytic FC radial capacitor available from Panasonic as Part No. EEU-FC1E101S. Resistor 940 is a ¼ Watt 5% carbon film 470 Ohm resistor available from Yageo as Part No. CFR-25JB470R. Diode 926 is a 1 amp 40PIV schottky barrier rectifier available from General Semiconductor as Part No. IN5819. LED 942 is a 5 mm green diffused diode available from Lite-On as Part No. 4233. Illustratively voltage regulators 928 and 930 are 1 amp low drop-out 5.0 volt regulators available from National Semiconductor as Part No. LM2940CT-5.0

FIGS. 18E-F show the connections between four pin header 873 and an off board key switch 875. Pin (1) of header 873 is coupled to 12V, pins (2 and 3) of header 873 are coupled to ground 801, and pin (4) of header 873 is coupled to PE5/INT5 pin (7) of micro-controller 944. Off board key switch 875 which is coupled to ground and to PE5/INT5 pin (7) of micro-controller 944. Illustratively header 873 is a four pin 0.100 straight friction lock header available from Molex as Part No. 22-23-2041. Keyswitch may be any type of normally open keyswitch which the operator wishes to instal.

FIG. 18G illustrates the on board components connected through 8strand ribbon wire to keypad 558. Header 877 includes pins (1-4) which receive signals from columns 1-4 respectively of keypad 558 and pins (5-8) which receive signals from rows 1-4 respectively of keypad 558. When any of the sixteen keys on 30 keypad 558 are pushed two signals are sent, one corresponding to the row of the key pushed and one corresponding to the column of the key pushed. Pin (1) of header 877 is coupled through resistor 879 to pin (2) of resistive element 881, through capacitor to ground 801, and to PF0/ADC0 pin (61) of micro-controller 944. Pin (2) of header 877 is coupled through resistor 885 to pin (3) of resistive element 881, through capacitor 887 to ground 801, and to PF1/ADC1 pin (60) of micro-controller 944. Pin (3) of header 877 is coupled through resistor 889 to pin (4) of resistive element 881, through capacitor 891 to ground 801, and to PF2/ADC2 pin (59) of micro-controller 944. Pin (4) of header 877 is coupled through resistor 893 to pin (5) of resistive element 881, through capacitor 895 to ground 801, and to PF3/ADC3 pin (58) of micro-controller 944. Pin (5) of header 877 is coupled through resistor 897 to pin (6) of resistive element 881, through capacitor 899 to ground 801, and to PB3/MISO pin (13) of micro-controller 944. Pin (6) of header 877 is coupled through resistor 901 to pin (7) of resistive element 881, through capacitor 903 to ground 801, and to PB4/PWMO pin (14) of micro-controller 944. Pin (7) of header 877 is coupled through resistor 905 to pin (8) of resistive element 881, through capacitor 907 to ground 801, and to PB5/OC1A/4/PWM1A pin (15) of micro-controller 944. Pin (8) of header 877 is coupled through resistor 909 to pin (9) of resistive element 881, through capacitor 911 to ground 801, and to PB6/OC1B/4/PWM1B pin (16) of micro-controller 944. Pin (1) of resistive element is coupled to V_{CC} 803. Illustratively, header 877 is an eight pin 0.100 right angle friction lock header available from Molex as Part No. 22-05-3081. Illustratively resistors 879, 885, 889, 893, 897, 901, 905, and 909 are ¼ Watt 5% carbon film 47 Ohm resistors available from Yageo as Part No. CFR-25JB 47R. Illustratively capacitors 883, 887, 891, 895, 899, 903, 907, 911 are ceramic monolithic 0.01 microfarad 50 volt 20% capacitors available from Panasonic as part No. ECU-S1H103KBA. Resistive element 881 is a 10 Kilo-ohm resistive nine element network element available from Panasonic as Part No. EXB-F10E103G.

Referring to FIGS. 18H and I, Micro-controller with flash memory 944 is shown coupled to 16×1 line display 556. Illustrated micro-controller 944 is an 8-bit AVR micro-controller with 128 K bytes of in-system programmable flash memory available from Atmel as Part No. ATMega 103. The remaining connections to micro-controller 944 not previously described are described below.

V_{CC}pins (21 and 52) of micro-controller 944 are coupled to V_{CC} 803 and through capacitors 946 and 948 to ground 801. GND pins (22 and 53) of micro-controller 944 are coupled to ground 801. AVCC pin 64 is coupled to AREF pin 62 at a node which is coupled through capacitor 950 to AGND pin (63) of micro-controller 944 and ground 801. This same node is coupled through resistor 952 to V_{CC}803. Reset′ pin (20) is coupled to pin (10) of programming port 962 and through resistor 954 to /RST pin 6 of MicroMonitor chip 956 and through resistor 958 to VCC 803. /ST pin 7 of MicroMonitor chip 956 is coupled to PE7/INT7 pin (9) of micro-controller 944. RST pin (5) of MicroMonitor chip 956 is coupled to through resistor 991 to MR pin (39) of UART 966 and through resistor 960 to VCC 803. VCC pin (8), /PER pin (1), and TD pin (2) of MicroMonitor chip 956 are coupled directly to VCC 803, and TDL pin(3) and GND pin (4) of MicroMonitor chip 956 are coupled directly to ground 801. MicroMonitor chip 956 is available from Dallas Semiconductors as Part No. DS 1232. The resistors and capacitors have the values as shown in the schematic.

Programming of micro-controller 944 is accomplished through connecting to in-system programming port 962. Programming port 962 is a shrouded straight ten pin header available from 3M as Part No. 2510-6002UB. Referring to FIGS. 18H and J, Pin (1) of programming port 962 is coupled to VCC 803. Pin (4) of programming port 962 is coupled to PE0/PDI/RXD pin (2) of micro-controller 944. Pin (6) of port 962 is coupled to PE1/PDO/TXD pin (3) of micro-controller 944. Pins (7 and 9) of programming port 962 are coupled to ground 801. Pin (8) of port 962 is coupled to PB1/SCK pin (11) of micro-controller 944.

Referring to FIGS. 18H and I, the interconnection between microcontroller 944 through ribbon wire 968 with 16×1 line display 556 is shown. PD1/INT1 pin (26) of micro-controller 944 sends E signal through ribbon wire to pin (6) of 16×1 line display 556. PD2/INT2 pin (27) of micro-controller 944 sends RS signal through ribbon wire 968 to pin (4) of 16×1 line display 556. PD3/INT3 pin (28) of micro-controller 944 sends R/˜W signal through ribbon wire 968 to pin (5) of 16×1 line display 556. PD4/IC1 pin (29) of micro-controller 944 sends DB4 signal through ribbon wire 968 to pin (11) of 16×1 line display 556. PD5 pin (30) of micro-controller 944 sends DB5 signal through ribbon wire 968 to pin (12) of 16×1 line display 556. PD6/T11 pin (31) of micro-controller 944 sends DB6 signal through ribbon wire 968 to pin (13) of 16×1 line display 556. PD7/TI2 pin (32) of micro-controller 944 sends DB7 signal through ribbon wire 968 to pin (14) of 16×1 line display 556. Pin (1) 16×1 line display 556 is coupled to ground 801, and pin (2) of 16×1 line display 556 is coupled to VCC 803. Pin (3) of 16×1 line display 556 is coupled to voltage divider formed by resistors 970 and 972 to VCC 803 and ground 801 respectively.

Referring to FIGS. 18Hand M, XTAL1 pin (24) of micro-controller 944 is coupled through capacitor 976 to ground 801 and through resistor 978 to OUT pin (5) of oscillator 980. Out pin (5) of oscillator 980 is coupled resistor 988 to XIN pin 18 of UART 966. (See FIG. 18K). VDD pin 8 of oscillator 980 is coupled through resistors 982 and 984 forming a voltage divider to ground 801. OE pin (1) of oscillator 980 is coupled through resistor 984 to ground 801. GND pin (4) of Oscillator 980 is coupled to ground 801 and through capacitor 986 to VCC 803.

Referring to FIGS. 18H, K and L, the connections providing communication between micro-controller 944 and printer 250 are shown. PA0-7/ADD0-7 pins (51, 50, 49, 48, 47, 46, 45, 44) of micro-controller 944 respectively are coupled to pins (2-9) respectively of Resistive element 964 and D0 pin (2) of UART 966, D1 pin (3) of UART 966 D2 pin (4) of UART 966, D3 pin (5) of UART 966, D4 pin (6) of UART 966, D5 pin (7) of UART 966, D6 pin (8) of UART 966, and D7 pin (9) of UART 966 respectively. PC7/AD15 pin (42) of micro-controller 944 is coupled to CS2′ pin (43) of UART 966. WR′ pin (33) of micro-controller 944 is coupled to WR′ pin (20) of UART 966. RD′ pin (34) of micro-controller 944 is coupled to RD′ pin (24) of UART 966. PC0-2/AD8-10 pins (35-37) of micro-controller 944 are coupled to A0-2 pins (31, 30, 29) of UART 966 respectively. INTR pin (33) of UART 966 is coupled to in input pin (6) of NOR gate 989 which is coupled at its other input pin (5) to ground 801 and at its output pin 4 to PD0/INT0 pin 25 of micro-controller 944. This allows micro-controller 944 to communicate through Universal Asynchronous Transmitter/Receiver (“UART”) 966 (see FIG. 18K) with printer 250. Illustratively UART 966 is available from National Semiconductor as Part No. PC16550DV.

WR pin (21) and Vss pin (22) of UART 966 are coupled to each other and then directly to ground 801. RD pin (25) and ADS′ pin (28) of UART 966 are coupled directly to ground 801. XIN pin (18) is coupled though capacitor 990 to ground 801. RI′ pin 43 and VDD pin 44 of UART 966 are coupled to each other, are coupled through capacitor 992 to ground 801, are coupled through capacitor 993 to ground 801 and are coupled to VCC 803. CTS′ pin 40is coupled through resistor to ground 801. DCD′ pin 42 is coupled through resister 995 to ground 801. CS0 pin (14) and CS1 pin (15) of UART 966 are coupled to each other and then through resistor 996 to VCC 803. RCLK pin (10) of UART 966 is coupled directly to BAUDOUT′ pin (17) of UART 966.

Referring to FIGS. 18K and L, the connections between UART 966 and the RS-232 printer/CPU interface 996 are shown. DSR′ pin (41) of UART 966 is coupled to R2OUT pin (9) of interface 996. SIN pin (11) of UART 966 is coupled to R1OUT pin (12) of interface 996. SOUT pin 13 of UART 966 is coupled to T11N pin (11) of interface 996. C1+ pin (1) is coupled through capacitor 945 to C1− Pin(3) of interface 996. C2+ pin (4) is coupled through capacitor 947 to C2− pin (4) of interface 996. V+ pin (2) of interface 996 is coupled through capacitor 949 to ground 801. V− pin (6) of interface 996 is coupled through capacitor 951 to ground 801. R2IN pin (8) of interface 996 is coupled to pin (3) of connector 997. R1IN pin (13) of interface 996 is coupled to pin (3) of connector 997. T1OUT pin (14) of interface 996 is coupled to pin 2 of connector 997. Pin (1) of connector 997 is coupled to pin (6) of connector 997. Pin (7) of connector 997 is coupled to pin (8) of connector 997. Pin (5) of connector 997 is coupled to ground 801. illustratively connector 997 is a D-shell 9 pin female connector available from Altex-Mar as Part No. DPRM-9S9HS. When connector 997 is coupled by printer cable 539 to printer 250, information collected by pulse collector unit 530 and stored by credit controller 544 can be printed on printer 250.

Referring to FIGS. 18H and N, the connections between micro-controller 944 and integrated circuit 999 are illustrated.PE3/AC− pin (38) of micro-controller 944 is coupled to SCL pin (2) of integrated circuit 999. SCL Pin (2) of integrated circuit 99 is also coupled through resistor 961 to VCC 803. PE2/AC+ pin (37) of micro-controller 944 is coupled to SDA pin (3) of integrated circuit 999. SDA pin (3) of integrated circuit 99 is also coupled through resistor 963 to VCC 803. GND pin (5) of integrated circuit 999 is coupled to ground 801.RST′ pin (7) of integrated circuit 999 is coupled to pin (10) of programming port 962 and to Reset′ pin (20) of micro-controller 944. Int′ pin (14) of integrated circuit 999 is coupled through resistor 965 to VCC 803.V_{DD} pin (11) of integrated circuit 999 is coupled through capacitor 967 to DS1 pin (8) of integrated circuit 999. From node 969VDD pin (11) and capacitor 967 are coupled to cathode of diode 971 which is coupled at its anode to VCC 803. From node 969VDD pin (11) and capacitor 967 are coupled to cathode of diode 9731 which is coupled at its anode to positive terminal of 3 volt battery 975 which is coupled at its negative terminal to ground 801. Illustratively integrated circuit is Part No. RTC-8593. The diodes, resistors and capacitors have the values shown in the schematic.

As shown in FIGS. 18H and O, credit controller 544 is configured to provide an audible alert tone. PB7/OC2/PWMs pin (16) of micro-controller 944 is coupled through resistor 977 to ground 801 and through resistor 979 to the base of transistor 981. The emitter of transistor 981 is coupled to ground 801. The collector of transistor 981 is coupled to pin (2) of speaker 983 to first lead of resistor and to first lead of 50 mH inductor 987. The second leads of resistor 985 and inductor 987 are coupled to pin (1) of speaker 983, through resistor 941 to VCC803, and through capacitor 943 to ground 801.

During operation of game controller 510, power up is accomplished by first turning on the power for gaming machine 12 which will cause pulse collection unit's power LED 742 to illuminate. Next the power is turned on for Printer 250. Then power is turned on for the credit controler 544 causing its power LED 942 to illuminate. Micro-controller 944 is programed to cause display 556 to go through a startup routine causing it to display the date and time. Game controller 510 is then ready for use.

Game controller 519 is configured to allow four types of tickets to be printed by printer 250, a redemption ticket, a bartender ticket, a route person ticket and a manager/owner ticket. Bartender ticket prints a ticket with OUT CREDITS only for all game transactions. A manager ticket prints with IN & OUT CREDITS for all games with transactions. A route ticket includes IN & OUT CREDITS for all games with transactions.

In order to print a redemption ticket, the user must press GAME 561 on key pad 558. Display 556 then requests the gaming machine 12 ID tag number. The user enters the ID tag of the gaming machine 12 to be cleared and presses Enter 563 on keypad 558. Printer 250 prints the game ticket after credits have been transferred from pulse control unit 530 to credit controller 544.

In order to print an accounting ticket, the user must press ACCT 565 on keypad 558. Display 556 then requests a 4 digit CODE which must be entered by the user prior to pressing Enter 563 on keypad 558. The printer 250 will print Accounting ticket only if the proper 4 digit code is entered. There are three types of accounting tickets which may be printed

Whenever a player inserts currency in a gaming machine 12, the pulse collection unit for that machine accumulates credits. While credits are being accumulated LED 688 flashes to show IN credits are accumulating. When the player is finished playing and wants to redeem credits an indication is made to the operator who accesses credit controller 544, presses GAME 561 on the keypad 558. In response to the message on Display 556 requesting the game #, the operator enters the decimal equivalent of the binary ID tag entered on DIP switch 536 of the pulse collection unit installed in the gaming machine 12. The decimal equivalent of the ID tag appears on display 556. If this number is correct the operator presses ENTER 565. If the number displayed is incorrect, the operator may press cancel and begin the process again. Once ENTER 563 has been pushed, credit controller 544 finds the Pulse collector unit 530 having the ID tag set on its 8-pin DIP switch 537 corresponding to the decimal number entered. Once the credit controller finds the appropriate pulse collection unit 530, a signal is sent to Pulse collector unit 530 to clear credits.

Pulse collector unit 530 accumulates out credits in memory. While the Pulse collector unit 530 accumulates credits Credit controller 544 communicates with Pulse collector unit 530 to see when completed. Once Pulse collector unit 530 has completed dumping credits then it will update Credit controller 544 with current “in and out” credit counts. After Credit controller 544 has been updated the Credit controller 544 tells Pulse collector unit 530 to clear “in and out” memory and resets to zero. Once Pulse collector unit 530 has reset to zero the Credit controller 544 establishes communication through printer cable 539, sends the appropriate data to printer 250 and commands printer 250 to print a ticket.

Credit controller 544 stores three records for accounting purposes: 1) “outs” for redemption area; 2) “In and outs for location; and 3) ” In and out“for route person. The first set of records is for bartender tickets. When the bartender presses ACCT565 on keypad 558, display 556 displays a request for a four digit code. Once this is entered on keypad 558 and ENTER 563 is pressed, an accounting ticket is printed by printer 250 which includes “OUTS” only so bartender can balance out with prior redemption tickets for the day. This only prints games that were paid out on this ticket.

In order to print a manager ticket a similar procedure is followed. However the four digit code for the manager ticket is location specific and differs from the bartender code. After the code has been entered and ENTER 563 has been pushed, a ticket is printed giving “IN's & OUT's. In order to print a route ticket a similar procedure is followed, only a different 4 digit code is entered. The route ticket gives IN's & OUT's information for the location.

The operation of the game controller 544 is as follows:

1) if the operator requests a redemption ticket then:

Credit controller 544 Sends command to Pulse collector unit 530 to clear credits;

Credit controller waits for response with IN & OUT credits counts;

If Pulse collector unit 530 responds, then:

Print game ticket;

Update local total IN & total OUT counts with new values;

Send reply to Pulse collector unit 530 that counts were successfully transferred;

If Pulse collector unit 530 is not in the active list, then add it;

If Pulse collector unit 530 does not respond (after several attempts to cash-out), then display warning to operator in LCD screen;

2) If operator requests accounting ticket, then:

Poll each active Pulse collector unit 530 for additional IN counts;

Update local total IN & OUT counts with new values;

Reply to each active Pulse collector unit 530 that counts were successfully transferred;

Print accounting ticket.

The operation of pulse collector unit 530 is as follows. After power up the current counts are acquired from flash memory of micro-controller 700. The setting of three position DIP switch 535 is read to determine the transmitting and receiving frequency and the settings of the eight position DIP switch 536 is read to determine the machine ID Tag. Micro-controller 700 the begins a loop as follows:

If IN-COUNTS received, then update IN-COUNTS in memory;

If poll IN-COUNTS request received, then:

Send IN-COUNTS to Credit controller 544;

Updated IN-COUNTS for BAR, MANAGER, ROUTE with new values;.

When Credit controller 544 responds with counts received, clear IN-COUNTS in memory;

If OUT-COUNTS received, then update OUT-COUNTS in memory;

If poll OUT COUNTS request (CASH-OUT command) received, then:

Send CASH-OUT signal to game equipment;

Update OUT-COUNTS with new values;.

When Credit controller 544 responds with counts received, clear OUT-COUNTS in memory;

If Credit controller 544 does not respond with counts received (after several attempts),

Begin flashing counts help LED. The Credit controller 544 center will have to re-request the OUT-COUNTS and correctly receive them to clear this error condition.

Credit controller 544 and pulse collection units 530 send several different command to each other during operation. Among the commands are an Acknowledge, a Dump credits, a POLL command trying to see how many credits machine has, a BUSY command meaning the Pulse collector unit 530 busy a CREDITS command for updating IN & OUT credits from Pulse collector unit 530, and a RESET command telling Pulse collector unit 530 to clear its memory.

In order to clear accounting records, the operator presses RESET 559 reset and enters a code (bartender, manager and route person). When ENTER 563 is pressed credit controller 544 all current records for that code only.

Although the invention has been described in detail with reference to a preferred embodiment, variations and modifications exist within the scope and spirit of the invention as described and defined in the following claims.

What is claimed is:

1. A game-credit control apparatus suitable for use with gaming machines each configured to store accumulated credits in response to a game and to transmit a counter signal of accumulated credits in response to receiving a reset signal, the game-credit control apparatus comprising a credit controller remotely located from the gaming machine communicating with a game unit installed in each gaming machine, the credit controller formed to selectively trigger a reset signal conveyed to the gaming machine by the game unit, each game unit having a tag capable of distinguishing it from other game units, and a payout counting mechanism communicating with the game unit, the payout counting mechanism being formed to receive the counter signal of accumulated credits.

2. The game-credit control apparatus of claim 1, wherein the payout counting mechanism is formed to display the accumulated credits transmitted by the counter signal.

3. The game-credit control apparatus of claim 2, further comprising an accounting mechanism in communication with the game unit and the accounting mechanism is formed to display the accumulated credits transmitted by the counter signal.

4. The game-credit control apparatus of claim 1 wherein the communication between the credit controller and the game unit is wireless over a channel.

5. The game-credit control apparatus of claim 4 wherein the game unit and the credit controller are both configurable to transmit and receive on a plurality of channels and the credit controller and the game unit are configured to transmit and receive on the same channel.

6. The game-credit control apparatus of claim 5 wherein the plurality of channels are in the 900 MHZ band.

7. The game-credit control apparatus of claim 4 wherein the credit controller is configured to generate and transmit a signal containing a tag and an indication that a game unit associated with the tag should generate a reset signal to be communicated to the gaming machine.

8. The game-credit control apparatus of claim 1 wherein the tag is a multi-bit binary I.D. number.

9. The game-credit control apparatus of claim 8 wherein the game unit includes a tag generator, a processor, and a receiver, the tag generator being coupled to the processor to provide a signal indicative of the tag and the receiver communicates data received from the credit controller to the processor which generates signals to the game machine when the data communicated from the receiver includes tag data corresponding to the signal indicative of the tag.

10. A gaming system comprising:
a plurality of gaming machines each configured to store accumulated credits in response to a game and to transmit a counter signal of accumulated credits in response to receiving a reset signal,
a plurality of game units each of which is installed in a different one of each of the plurality of gaming machines to transmit the reset signal to and receive the counter signal from the gaming machine in which it is installed and includes a tag capable of distinguishing it from other game units,
a credit controller remotely located from the gaming machine communicating with the plurality of gaming units to selectively trigger the generation of the reset signal, and
a payout counting mechanism communicating with each of the plurality of game units, the payout counting mechanism being formed to receive the counter signal of accumulated credits.

11. The gaming system of claim 10 wherein the communication between the credit controller and each game unit is wireless over a channel.

12. The gaming system of claim 11 wherein each game unit and the credit controller are configurable to transmit and receive on a plurality of channels and the credit controller and each game unit are configured to transmit and receive on the same channel.

13. The gaming system of claim 11 wherein the plurality of channels are in the 900 MHZ band.

14. The gaming system of claim 10 wherein the credit controller is configured to generate and transmit a signal containing a tag and an indication that a game unit associated with the tag should generate a reset signal to be communicated to the gaming machine.

15. The gaming system of claim 10 wherein the tag is a multi-bit binary I.D. number.

16. The gaming system of claim 15 wherein each game unit includes a tag generator, a processor, and a receiver, the tag generator being coupled to the processor to provide a signal indicative of the tag and the receiver communicates data received from the credit controller to the processor which generates signals to the game machine when the data communicated from the receiver includes tag data corresponding to the signal indicative of the tag.

17. A gaming system for use in an establishment having a collection area wherein game credits are redeamed remotely located from a game area, the gaming system comprising:
a plurality of gaming machines located in the game area, each gaming machine having a game board for tracking credits earned and lost through game play and credits purchased on that gaming machine and storing the tracked information as credit data until a reset signal is received;
a game control aparatus including:
a plurality of game units each of the plurality of game units being located with a different one of the plurality of gaming machines in the game area, each game unit having:
a wireless receiver;
a wireless transmitter;
selectively activatable reset signal generating circuitry for generating a reset signal, the reset signal generating circuitry being communicatively coupled to the game board of a gaming machine for communicating a reset signal to the game board when activated by receipt of an activating signal;
a distinct I.D. tag associated therewith;
tag recognition circuitry communicating with a wireless receiver for receiving signals containing tag information and communicating with the reset signal generating circuitry for sending an activating signal upon receipt of a signal containing the distinct I.D. tag information associated therewith;
memory communicating with the game board for receiving credit data information upon receipt of a reset signal by the game board and communicating with the wireless transmitter for sending received credit data to the wireless transmitter,
a credit controller located in the collection area, the credit controller including:
signal generating circuitry for generating output signals containing tag information based on an input,
a user interface communicating with the signal generating circuitry for providing an input determining the tag information contained in the signals containing tag information;
a wireless transmitter configured to communicate with the wireless receivers of the plurality of game units, the wireless transmitter coupled to the signal generating circuitry to receive and transmit the signal containing tag information;
a wireless receiver configured to communicate with the wireless transmitters of the plurality of game units to receive credit data;
memory for storing credit data received;
a processor coupled to the memory for configuring the credit data for output.

18. The gaming system of claim 17 further comprising a printer coupled to the processor of credit controller whereby the credit controller is configured to generate print data used by the printer to print a voucher containing credit data.

19. The gaming system of claim 18 wherein the print data generated by the processor is dependent on the type of code information received and the user interface is coupled to the processor to allow a user to input code information.

20. The gaming system of claim 19 wherein the code information recognized by the processor is selected from the group containing voucher code information, bartender code information, route person code information and manager code information and wherein the print data generated by the processor is dependent on the code information entered.

21. The gaming system of claim 20 wherein upon recognition of bartender code information, processor generates bartender voucher print data to generate a bartender voucher containing credit data indicating the credits redeamed at the collection area.

22. The gaming system of claim 21 wherein the credit data indicating credits redeamed at the collection area includes an indication of total credits redeamed and credits redeamed for each of the plurality of gaming machines from which credits were redeamed.

23. The gaming system of claim 20 wherein upon recognition of route person code information, processor generates route person voucher print data to generate a route person voucher containing credit data indicating the credits purchased and credits redeamed at the collection area.

24. The gaming system of claim 23 wherein the credit data indicating credits redeamed at the collection area and credits purchased includes an indication of total credits redeamed and credits purchased for all of the plurality of gaming machines upon which credits were purchased and credits purchased and credits redeamed on each of the plurality of gaming machines from which credits were purchased.

25. The gaming system of claim 20 wherein upon recognition of manager code information, processor generates manager voucher print data to generate a manager voucher containing credit data indicating the credits purchased and credits redeamed at the collection area.

26. The gaming system of claim 23 wherein the credit data indicating credits redeamed at the collection area and credits purchased includes an indication of total credits redeamed and credits purchased for all of the plurality of gaming machines upon which credits were redeamed and credits purchased and credits redeamed on each of the plurality of gaming machines from which credits were redeamed.

27. The gaming system of claim 17 wherein credits may only be redeamed at the collection area.

28. The gaming system of claim 17 wherein credits may only be purchased at the gaming machines.
